(19) United States
(12) Patent Application Publication
(10) Pub. No.: US 2026/0298722 A1
(43) Pub. Date: Oct. 1, 2026

(54) METHOD AND SYSTEMS FOR TUNING COHERENCE IN SYSTEMS

(71) Applicant: Sean Null, Kansas City, MO (US)

(72) Inventor: Sean Null, Kansas City, MO (US)

(21) Appl. No.: 19/699,725

(22) Filed: Jun. 5, 2026

Related U.S. Application Data
(63) Continuation-in-part of application No. 19/204,192, filed on May 9, 2025.
(63) Continuation-in-part of application No. 19/204,177, filed on May 9, 2025, now Pat. No. 12,695,000.
(63) Continuation-in-part of application No. 19/080,395, filed on Mar. 14, 2025.
(63) Continuation-in-part of application No. 19/186,010, filed on Apr. 22, 2025, now Pat. No. 12,704,572.
(60) Provisional application No. 63/818,383, filed on Jun. 5, 2025.
(60) Provisional application No. 63/829,227, filed on Jun. 24, 2025.
(60) Provisional application No. 63/887,686, filed on Sep. 25, 2025.
(60) Provisional application No. 63/978,037, filed on Feb. 9, 2026.

(51) Int. Cl. G01J 9/00; G06N 10/20; G06N 10/40; G06N 10/70; H01S 3/00

(52) U.S. Cl. CPC G01J 9/00; G06N 10/20; G06N 10/40; G06N 10/70; H01S 3/0085

(57) ABSTRACT

Methods and systems for tuning coherence of computing systems involve a modulation engine including at least one processor and a memory. A modulation device is connected to the modulation engine. The modulation device is configured to adjust an operating parameter of the computing system based on coherence outputs from the modulation engine to reduce coherence loss of the computing system.

### CROSS-REFERENCE TO RELATED APPLICATIONS

This application is a continuation-in-part of U.S. Non-provisional application Ser. No. 19/204,192, titled METHOD AND SYSTEM FOR GENERATING OR MANIPULATING STRUCTURED VACUUM ENERGY FIELDS, and filed May 9, 2025, U.S. Non-provisional application Ser. No. 19/204,177, titled METHOD AND SYSTEM FOR GENERATING OR MANIPULATING STRUCTURED VACUUM ENERGY FIELDS, and filed May 9, 2025, U.S. Non-provisional application Ser. No. 19/080,395, titled METHODS AND SYSTEMS FOR QUANTUM OPERATION EXECUTION INCLUDING FLUX FIELD STABILIZATION ENGINE, and filed Mar. 14, 2025, and U.S. Non-provisional application Ser. No. 19/186,010, titled METHODS AND SYSTEMS FOR COMPUTING OPERATION EXECUTION INCLUDING FLUX FIELD STABILIZATION ENGINE, and filed Apr. 22, 2025; and this application claims priority to U.S. Provisional Application No. 63/978,037, titled DETERMINISTIC EXECUTION REFERENCE ASSERTION FOR COMPUTING SYSTEMS, and filed Feb. 9, 2026, U.S. Provisional Application No. 63/818,383, titled METHOD AND SYSTEMS FOR TUNING COHERENCE IN SYSTEMS USING VACUUM ENERGY FIELD MODULATION, and filed Jun. 5, 2025, U.S. Provisional Application No. 63/829,227, titled SYSTEMS AND METHODS INCLUDING TENSOR CONTROL ENGINE FOR CURVATURE-BASED OPERATION INJECTION, and filed Jun. 24, 2025, U.S. Provisional Application No. 63/887,686, titled ENHANCED COMPUTING SYSTEM UTILIZING BASIS-DEPENDENT COHERENCE PRESERVATION, and filed Sep. 25, 2025, and U.S. Provisional Application No. 63/887,695, titled COMPUTE SYSTEM UTILIZING BASIS-DEPENDENT COHERENCE PRESERVATION, and filed Sep. 25, 2025. The entire contents and disclosures of the foregoing applications are incorporated by reference in their entirety.

### TECHNICAL FIELD

The field of the disclosure relates to systems and methods for modeling and tuning coherence using a modulation engine.

### BACKGROUND

Coherence loss of systems reduces the performance of the systems, decreases possible runtime, and has other effects on the systems. Enhanced computing systems, e.g., quantum computers and quantum systems, are highly susceptible to decoherence, which leads to the loss of information and limits the performance of operations. For example, the decoherence process can suppress the coherence of a quantum state, often manifesting as the rapid decay of off-diagonal elements in a density matrix in a specific measurement basis, such as the computational (Z) basis. This presents a significant challenge for executing quantum algorithms with high fidelity.

Previous methods for managing coherence in systems have focused on passive observation and indirect control techniques. These approaches often involve measuring environmental parameters or system outputs, without directly engaging with energy fields. For example, some systems have used empirical adjustments to system parameters based on observed coherence degradation, rather than predictive or calculated modulation of energy fields. These methods typically rely on stochastic processes and lack the ability to dynamically calculate coherence amplitudes or outputs based on energy field characteristics.

### BRIEF DESCRIPTION

In some aspects, a system for tuning coherence of a computing system using energy fields includes a modulation engine and a modulation device. The modulation engine identifies an energy field associated with the computing system, determines a resonant frequency for the energy field, determines a modulation field for the energy field, calculates a coherence amplitude based on the resonant frequency and the modulation field, and determines a coherence output based on the coherence amplitude. The modulation device is connected to the modulation engine and is configured to adjust an operating parameter of the computing system based on the coherence output to reduce coherence loss of the computing system.

In some aspects, a method for tuning coherence in a system involving energy fields includes identifying an energy field associated with an element of the system, determining a resonant frequency for the energy field, determining a modulation field for the energy field, calculating a coherence amplitude based on the resonant frequency and the modulation field, determining a coherence output based on the coherence amplitude, and adjusting an operating parameter of the system based on the coherence output to reduce coherence loss.

In some aspects, a method of operating an enhanced computing system includes initiating a quantum operation involving a qubit of the enhanced computing system, measuring a quantum state of the qubit based in a Z-axis, identifying a Z-basis decoherence if the quantum state based in the Z-axis indicates a coherence value of the qubit based in the Z-axis that is at or less than a suppressed threshold, determining gate operators to rotate the qubit relative to at least one of the X-axis or the Y-axis based on the quantum state measured in the Z-axis, rotating the qubit relative to at least one of the X-axis or the Y-axis by applying the gate operators, and executing the quantum operation on the enhanced computing system in accordance with a modified quantum algorithm that replaces rotations about the Z-axis with rotations about the X-axis or the Y-axis for portions of the execution subject to Z-basis decoherence.

### BRIEF DESCRIPTION OF THE DRAWINGS

FIG. 1 is a partially schematic diagram of an example computing system including a modulation engine.

FIG. 2 is a partially schematic diagram of an example of a modulation device configured to deliver a modulation field to an element.

FIG. 3 is a flow diagram of an example method for generating a structured energy field.

FIG. 4 is a flow diagram of an example method for modulating energy fields.

FIG. 5 is a multi-dimensional surface plot generated from an exponential modulation profile showing application of a modulation field.

FIG. 6 is a multi-dimensional surface plot of a modulation field illustrating a derived solution for a modulation field obtained from a Higgs-type potential.

FIG. 7 is a partially schematic diagram of an example system for manipulating structured vacuum energy interactions to process data.

FIG. 8 is a box diagram of an example symbolic inference engine.

FIG. 9 is a flow diagram of an example method for coherence modeling and manipulation based on vacuum energy fields.

FIG. 10 is a diagram comparing coherence amplitude to time for a system employing vacuum field modulation.

FIG. 11 is a partially schematic diagram of an example enhanced computing system.

FIG. 12 is a block diagram of an example quantum processor for use with the enhanced computing system shown in FIG. 11.

FIG. 13 is a partially schematic diagram of a portion of an example quantum processor including a quantum circuit.

FIG. 14 is a schematic diagram of a portion of an example quantum circuit.

FIG. 15 is a block diagram of an example integration of a basis-dependent coherence preservation engine.

FIG. 16 is a flow diagram of an example method of operating an enhanced computing system such as the enhanced computing system shown in FIG. 11.

The figures depict examples for purposes of illustration only. One skilled in the art will readily recognize from the following discussion that other examples of the systems and methods illustrated herein may be employed without departing from the scope of the disclosure. Any combination, rearrangement, or functional equivalent of the illustrated components are within the scope of the disclosure.

### DETAILED DESCRIPTION

As used herein, “vacuum energy field” may represent a physical vacuum phenomenon, a modeled field representation, or a modeled reference topology within a physical, symbolic, computational, logical, or hybrid domain. The present disclosure concerns deterministic coherence modeling and tuning using a structured modulation field and is not limited by the ontological interpretation of the underlying field.

An aspect of the present disclosure is the deterministic modeling of coherence amplitude as a function of resonant frequency and structured modulation parameters, and the use of the modeled coherence output to tune operating parameters of a system.

In an example, a system includes a modulation engine that actively regulates energy fields in real time and implements physics models (e.g., models of electromagnetic field behavior, including minute background fluctuations) to generate modulations within the energy fields and thereby structure the energy fields. The system also utilizes a generalized deterministic field-based modulation method for structuring vacuum energy.

Vacuum energy is traditionally modeled as arising from stochastic fluctuations in theorized fields. The stochastic modeling limits control over coherence, energy stability, and entropy. In some examples, the vacuum modulation engine of this disclosure introduces a deterministic framework for structured vacuum energy, which is governed by a modulation mechanism that imposes non-random structure on the vacuum. The vacuum modulation engine establishes the foundation for treating vacuum space not as a stochastic medium, but as a programmable structure. The vacuum modulation engine enables control over energy density in any physical or informational system through the application of deterministic vacuum modulation.

The structured vacuum energy model replaces the stochastic zero-point interpretation of vacuum fluctuations with a deterministic modulation field that provides a tunable structure. For example, the modulation field is used to generate structured fields and facilitate programmable control over vacuum energy density, entropy regulation, and/or system coherence. In examples, the modulation mechanism may be scalar, vector, tensor, topological, logical, symbolic, or computational in nature. As a result, the system is symbolic-agnostic, domain-independent, and invariant to representational transformation, thereby extending across mathematical, physical, computational, and logical implementations. The structured vacuum energy model utilizes a structured vacuum energy function that defines a deterministic energy framework applicable to systems interacting with any vacuum topology or logic.

Example applications of the vacuum modulation engine include employing a deterministic modulation of vacuum behavior to influence energy density, entropy regulation, symbolic stability, logical propagation, physical structure, or information coherence. The vacuum modulation engine encompasses the use of deterministic modulation fields to control and structure vacuum energy in any domain, whether physical, mathematical, symbolic, computational, or otherwise representational.

In an example, the vacuum modulation engine generates a structured vacuum energy field through the application of a deterministic modulation field that is calculated and tuned precisely for the energy field to be modulated. In some examples, the modulation field is presented as an isomorphic transformation, substitution schema, or encoded isomorphism, and/or has a symbolic or mathematical reformulation. The modulation field imposes non-stochastic modulation of vacuum behavior in the energy field. Any mathematical transformation, symbolic representation, or domain shift that preserves the coherence control dynamics is covered. In addition, the deterministic modulation field can be implemented in digital, analog, or hybrid forms, in addition to or in place of mathematical forms.

The vacuum modulation engine or described principles apply to any systems that rely on deterministic structuring of vacuum energy, inclusive of symbolic and/or mathematical representation, or any other suitable systems. Examples incorporate human-operated, artificial, algorithmic, and/or hybrid systems that generate or operate using structured vacuum modulation logic.

One example includes a computational simulation platform that deterministically modulates vacuum energy fields across symbolic or logical registers to generate coherent output states.

Another example includes an antenna device that applies topological modulation via the modulation field to increase or suppress vacuum-mode coupling.

Another example includes manipulating entropy-controlled logic gates to generate deterministic vacuum fluctuations for energy-efficient state transitions.

Another example includes a data encoding mechanism that uses structured vacuum interactions for symbolic information propagation in non-classical channels.

The systems and engines have implementation across many fields and domains and improve the performance of any system. For example, the vacuum modulation engine is implemented in non-physical domains, multi-domain coherence systems, frequency-layered structured vacuum energy architectures, cross-system derivative protocols, virtual vacuum substrates, and/or zero-interface embodiments.

In some examples, the vacuum modulation engine, using AI-driven algorithms (including predictive and generative models), dynamically tunes execution parameters of a computing system to generate structured patterns in the energy fields. For example, the vacuum modulation engine can adjust gate timing, execution order, or routing pathways of the computing system. The vacuum modulation engine adjusts the execution parameters to structure the energy fields based on a calculated modulation field to improve the performance of the computing system.

In some examples, the vacuum modulation engine combines advanced AI-based control with physical field modeling to create a self-optimizing processor. The vacuum modulation engine continuously monitors bit-level signal conditions and adjusts the modulated field(s) acting on the processor(s) in real time to ensure signals propagate with minimal interference and energy loss. As a result, the computing system maintains high fidelity of bit states and efficient power usage during computation.

In some examples, a system includes a basis-dependent coherence preservation engine that actively regulates coherence of computing units in real time and implements physics models (e.g., models of electromagnetic field behavior, including minute background fluctuations) to generate modulations of the system and preserve coherence. For example, the basis-dependent coherence preservation engine provides a measurable, reproducible effect because coherence persists in different axes even when one axis appears decohered. The basis-dependent coherence preservation engine facilitates identifying, interpreting, and utilizing the preserved coherence. As a result, the system provides improved performance of the computing systems and improved fidelity metrics. In addition, the system may be paired with transpillation platforms to provide transpillation routes that improve coherence by capitalizing on identified basis axes with slowed decay.

Implementations of the described systems and methods improve hardware performance of a computing system. For example, the vacuum modulation engine provides faster execution, lower power usage, and more stability beyond what traditional control loops achieve for computer processing. In addition, the system improves execution efficiency, reduces thermal bottlenecks, and increases system resilience to load fluctuations. For example, the vacuum modulation engine overcomes stochastic constraints in vacuum modeling, eliminates entropic drift in symbolic/logical systems, enhances computational substrates with field-aware control, and enables cross-domain symbolic consistency. Moreover, the described systems and methods enhance information coherence in distributed systems.

The described systems and methods provide an alternative to reliance on stochastic coherence assumptions. For example, the vacuum modulation engine enables programmable control of coherence and provides a universal modulation framework across symbolic, physical, or computational systems.

As a result, the described systems and methods provide a new class of hardware and/or software solutions that increase the speed and capabilities of computing systems by modeling and tuning coherence that influences substantially all aspects of the computing systems.

The approach can be applied to different hardware forms such as general-purpose computer processing units (CPUs), application-specific integrated circuits (ASICs), field-programmable gate arrays (FPGAs), superconducting logic circuits, neuromorphic hardware, AI co-processors, and/or any other architectures.

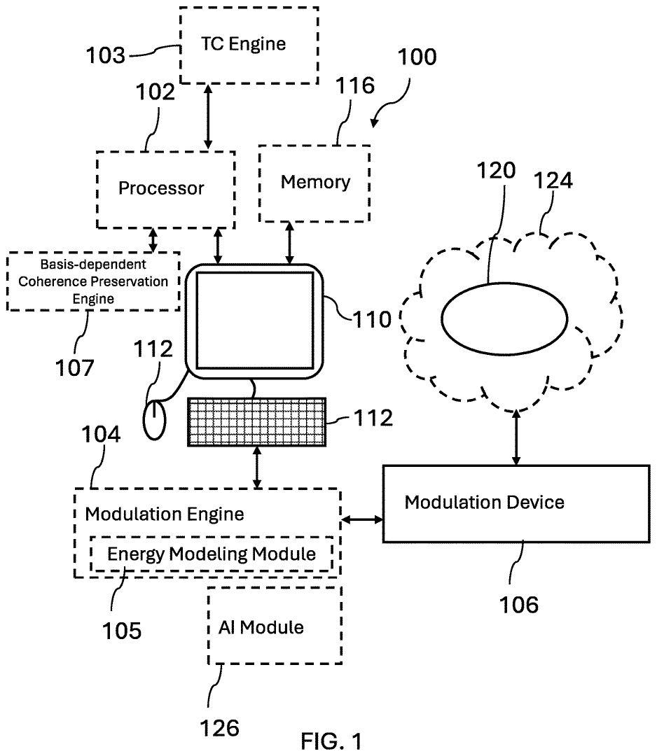

FIG. 1 is a partially schematic diagram of an example computing system, generally indicated at 100. The computing system 100 is configured, for example, to perform computer operations. The computing system 100 includes at least one processor 102 and a modulation engine 104. The modulation engine 104 is a module implemented in hardware and/or software that monitors signal parameters and adjusts parameters of the processor 102. For example, the modulation engine 104 can be implemented via electronic circuitry, firmware, and/or software instructions executed by a microcontroller, that perform the functions of the modulation engine 104. The modulation engine 104 operates the processor 102 as described below to, for example, manipulate and structure vacuum energy fields.

In addition, the computing system 100 may include any other components that facilitate the computing system 100 operating as described. For example, the computing system 100 includes a display device 110, an input device 112, and a memory 116. For example, the input device 112 may include a keyboard, a computer pointer device, a touch screen, a microphone, a camera, and/or any other suitable input device. The computing system 100 may include more or less components in some examples.

The memory 116 may be any type of memory capable of use with the computing system 100. For example, the memory 116 may comprise, but is not limited to, volatile storage (e.g., random access memory), non-volatile storage (e.g., read-only memory), flash memory, or any combination of such memories. For example, the computing system 100 may also include additional data storage media which may comprise devices (removable and/or non-removable) such as, for example, magnetic disks, optical disks, or tape. The memory 116 may include an operating system and one or more program modules or components suitable for performing the various described operations. The operating system may be suitable for controlling the operation of the computing system 100. In some examples, a portion of the memory 116 is stored on a database and accessed via a communication network (e.g., cloud storage).

As stated above, a number of program modules and data files may be stored in the memory 116. While executing on the processor 102, the program modules may perform the various processes, including, but not limited to, the aspects of the computing system 100, as described herein. For example, aspects of the modulation engine 104 are stored on the memory 116 and accessed by the processor 102 when performing operations. The program modules may be incorporated into an operating system, application, middleware, and/or any other program module.

In the example, the computing system 100 includes at least one of the processors 102. For example, the processor 102 may include one or more processing units, graphics units, communications units, system virtualization units, and various application functionality, all of which are integrated as a single integrated circuit or incorporated into multiple circuits.

Referring to FIG. 1, in addition, the modulation engine 104 includes a software-defined flux energy modeling module 105 that operates on the processor 102 and is configured to model a vacuum energy field 124 associated with an element 120. The vacuum energy field is a virtual field determined by the modulation engine 104 to represent an energy field (and associated energy distribution) generated by the element 120, including any ambient or environmental field influences. The vacuum energy field associated with the element 120 may be defined by a zone around the element 120 bounded by one or more dimensions (e.g., a geometric shape having at least three dimensions and encompassing the element 120) that is determined based on characteristics of the element 120. In some examples, the fields are determined with variables in two (e.g., x, y systems), three (e.g., x-y-z systems), four (e.g., x-y-z-t systems), or more dimensions. In some examples, the vacuum energy field 124 is not associated with a specific element 120 and is instead defined by a boundary (real or imaginary) and encompasses any energy (e.g., vacuums, electromagnetic fields, etc.) within the boundary.

The modulation engine 104 is configured to identify the vacuum energy field 124 associated with the element 120. For example, the modulation engine 104 identifies the element 120 and/or a boundary for the vacuum energy field 124 based on preset operating parameters of the system 100. For example, the modulation engine 104 may define the boundaries to align with a housing of the system, a determined field of influence for the field, a region of sensitivity or concern, or any other operating parameters. The modulation engine 104 may determine coordinates in a multi-dimensional (e.g., two, three, or more dimensions) coordinate system to define the boundary. The modulation engine 104 then identifies the vacuum energy field within the boundary based on the described principles.

The modulation engine 104 determines a resonant angular frequency of the vacuum energy field 124. For example, the modulation engine 104 determines the resonant angular frequency by at least one of retrieving the resonant angular frequency from the memory 116, receiving the resonant angular frequency as an input from an external source, receiving a sensor reading related to the resonant angular frequency, and/or calculating the resonant angular frequency. As used herein, the phrases “vacuum resonant angular frequency” or “resonant angular frequency” refer to a frequency at which the vacuum state of an energy field exhibits a peak in response to an external perturbation or due to inherent fluctuations amplified by specific boundary conditions or field interactions. The vacuum resonant angular frequency is a characteristic frequency related to the energy scales and dynamics of the vacuum state of a particular field within a given system or spacetime. The vacuum resonant angular frequency is expressed in radians per second and represented by the symbol “w” in equations. The vacuum-resonant angular frequency may vary as a function of spatial topology, boundary constraints, field configuration, or modulation structure. The vacuum resonant angular frequency is not fixed, and may shift under dynamic conditions imposed by a modulation field, represented by φs. Therefore, the structured modulation mechanism remains valid across all energetic domains of vacuum fluctuation.

The resonant angular frequency is calculated by determining the specific angular frequency at which a system oscillates with maximum amplitude when driven by an external force. For example, for an LC or RLC circuit, the resonant angular frequency is calculated using equation (1).

$${ω}_{0} = \frac{1}{\sqrt{L C}} \qquad Equation ( 1 )$$

where L is inductance in Henrys (H) and C is the capacitance in Farads (F).

The modulation engine 104 is configured to calculate a structured vacuum energy density based on the resonant angular frequency. For example, the vacuum modulation engine is configured to calculate the structured vacuum energy density by multiplying a reduced Planck constant and the resonant frequency and dividing the product of the reduced Planck constant and the resonant frequency by a product of a speed of light to a third power and a square of 2π. Equation (2) is an equation for calculating the structured vacuum energy density.

$${ρ}_{SVE} = \frac{h {ω}_{v}^{4}}{{( 2 π )}^{2} {c}^{3}} Φ s \qquad Equation ( 2 )$$

where ρ_{SVE} is structured vacuum energy density in Joules per cubic meter (J/m3), ℏ is a reduced Planck constant, ωᵥ is the vacuum-resonant angular frequency in radians per second, c is the speed of light in meters per second, and φs is the structured modulation field (unitless or normalized).

The modulation mechanism is represented with the symbol “φs” in these equations but may be represented in other manners and be within the scope of the disclosure. The modulation mechanism is not constrained to any specific symbol or formulation and may represent any deterministic field, operator, or structural logic applied to vacuum space. The modulation mechanism may appear as: scalar, vector, tensor, spinor, topological, or logical field; continuous or discrete; static or time-dependent; mathematical, computational, symbolic, or physical; acting over spacetime, frequency, momentum, or symbolic domains; propagating locally, non-locally, or instantaneously across any topological vacuum manifold; and/or functioning in physical, logical, or representational coordinate systems.

The modulation engine 104 uses the structured modulation field φs to modulate the amplitude or structure of vacuum energy as a deterministic function of frequency and applied field properties. The modulation engine 104 calculates the structured modulation field to provide a structure or amplitude of the vacuum energy based on predetermined parameters. For example, the modulation engine 104 calculates the structured modulation field using equations (3) and (4).

$$□Φ s + {V}^{′} ( Φ s ) = 0 \qquad Equation ( 3 )$$

$${V}^{′} ( Φ s ) = λ Φ s ( {Φ}_{s}^{2} - {v}^{2} ) \qquad Equation ( 4 )$$

where □φs=is a d'Alembert operator represented as ∂μ∂μ; φs is a structured modulation field in a scalar form; V(φs) is a scalar potential of φs; and V′(φs) is a derivative of the scalar potential. In the equation, the d'Alembert operator is a mathematical tool that extends the idea of the Laplacian (which describes how a quantity changes in space) to spacetime, incorporating how that quantity changes with time in a way that is consistent with Einstein's theory of relativity and facilitates describing waves and fields in that framework.

For at least some applications, Equations (3) and (4) may be generalized as Equation (5).

$$\partial μ ( f ( Φ s ) {\partial }^{μ} Φ s ) = {ρ}_{s} ( {x}^{α} ) \qquad Equation ( 5 )$$

where f(φs) is a tension modulation function, and ρₛ is a source/sink excitation or coherence injection.

In addition, the modulation engine 104 models or tunes coherence of systems based on vacuum energy. For example, the modulation engine 104 is configured to calculate the coherence amplitude using a time-dependent function. For example, Equation (6) provides a programmable coherence function that is dependent on time.

$$C ( t ) = {e}^{\frac{- 2 t}{Φ s}} cos ( {ω}_{s} t ) \qquad Equation ( 6 )$$

where (C(t)) is coherence amplitude, t is time (seconds), φs is the structured modulation field in a scalar form, and ωₛ is a structured vacuum coherence frequency (e.g., a resonant frequency).

As represented in Equation (6), the coherence function includes a decay component

$$( {e}^{\frac{- 2 t}{Φ s}} )$$

and an oscillatory term (cos(ωₛt)). For example, the oscillatory term is a cosine function of the resonant frequency multiplied by time. The decay term is multiplied by the oscillatory term to arrive at the coherence amplitude. In the example, the decay term is an exponential decay term and provides a damping (or decay) envelope. As time (t) increases, the exponent becomes more negative, and the value of this term approaches zero.

The structured modulation field (φs) provides a tunable coherence half-life and determines how quickly the amplitude of the oscillation decays. A larger structured modulation field (φs) means a slower decay (longer coherence time), while a smaller structured modulation field (φs) means a faster decay.

The oscillatory term (cos(ωₛt)) represents a standard cosine wave and generates a periodic (e.g., wave-like) behavior. The structured vacuum coherence frequency (ωₛ) determines how rapidly the wave oscillates.

The coherence amplitude function describes a damped harmonic oscillation in which the coherence amplitude oscillates sinusoidally (like a wave) over time. The amplitude of this oscillation is not constant but decreases exponentially over time. The damping term

$$( {e}^{\frac{- 2 t}{Φ s}} )$$

acts as a dynamic envelope for the cosine wave. For example, at t=0, the exponential term is e⁰=1, so C(0)=cos(0)=1 (assuming ωₛt=0 at t=0). As t approaches infinity, the exponential term approaches 0, causing C(t) to also approach 0, indicating a loss of coherence or the damping out of the oscillation.

Equation (6) models phenomena where a coherent state or an excited state loses coherence or energy over time while simultaneously oscillating. The structured modulation field (φs) facilitates modulation or tuning of the coherence amplitude to reduce coherence loss. For example, the structured modulation field is selected and injected into the framework to prolong the oscillation and/or increase the coherence amplitude delivered by the coherence function.

In examples, structured vacuum modulation fields are used to provide deterministic modeling of coherence and replace stochastic decay assumptions with programmable coherence via the modulation field. The application of the modulation field facilitates precise control of coherence loss and oscillation over time in physical, symbolic, and logical systems. The structured modulation field and coherence model integrate deterministic field logic into coherence evolution, entropy shaping, and symbolic propagation. Accordingly, tunable coherence and vacuum structuring using a universal modulation field is applicable across enhanced computing systems, symbolic AI, field theory, cryptographic inference architectures, software-defined infrastructure, middleware stacks, software development kits, and chip-level hardware deployments.

Based on the calculations, the modulation engine 104 operates the modulation device 106 to apply the modulation field to the vacuum energy field 124. For example, the modulation device 106 may be incorporated on a processor for a computational simulation platform and the modulation device 106 deterministically modulates vacuum energy fields of the computational simulation platform to generate coherent output states. In another example, the modulation device 106 includes a stimulator (e.g., an antenna) that applies topological modulation to the element 120 according to the modulation field. The topological modulation may include electrical current, light, temperature, and/or any other stimulator. In another example, the modulation device 106 includes an entropy-controlled logic gate that leverages deterministic vacuum fluctuations for state transitions. In a further example, the modulation device 106 includes a data encoding mechanism that applies modulation according to the modulation field to translate or encode data.

The modulation device 106 acting according to the modulation field causes a structured vacuum energy output to result from the vacuum energy field and the applied modulation field. The parameters of the structured vacuum energy output may be calculated using any combination of equations (1)-(6). For example, the structured vacuum energy output is a modulated vacuum energy field that includes vacuum energy arranged in a precise and controlled manner that is predictable based on the disclosed calculations and the applied modulation field and provides tunable characteristics of the system.

The modulation engine 104 modulates the vacuum energy associated with the element 120 to provide predetermined characteristics according to the structured vacuum energy output. For example, the modulation engine 104 is configured to determine the structured vacuum energy output and determine vacuum energy fluctuations based on the structured vacuum energy output.

Unexpectedly, control or structuring of the vacuum energy is possible using the disclosed equations. The structured vacuum energy provides precisely tunable characteristics and/or improved performance of systems based on the structured vacuum energy output. For example, the structured vacuum energy output is structured to modify an operating parameter or characteristic of the system 100, the element 120, and/or the environment of the system 100. For example, the modulation device 106 is configured to employ the structured vacuum energy output to regulate, for example and without limitation, at least one of energy density, entropy regulation, symbolic stability, logical propagation, physical structure, or information coherence.

In an example, the modulation engine 104 is configured to generate a computational simulation platform based on the structured vacuum energy density and the modulation field. The modulation device 106 receives the computational simulation platform from the modulation engine 104 and is configured to deterministically modulate, using the computational simulation platform, vacuum energy fields based on the structured vacuum energy density to generate coherent output states for symbolic or logical registers.

In another example, the modulation device 106 is configured to apply topological modulation using the modulation field to increase or suppress vacuum-mode coupling. In a further example, the modulation device 106 is configured to operate logic gates using the vacuum energy fluctuations to provide a selected range of energy state transitions. In still further examples, the modulation device 106 is configured to process data based on the vacuum energy fluctuations in information propagation.

In some examples, the modulation engine 104 provides structured modulation of vacuum energy and influences entropy distributions through deterministic constraints on local and global field variations. The modulation by the modulation engine 104 results in tunable entropy density, even in the absence of external energy exchange, and is governed solely by the behavior of the modulation field.

In some examples, the modulation engine 104 is generally hardware-agnostic and is compatible with a broad range of computing architectures, including superconducting bit platforms and any processing units. For example, the modulation engine 104 applies software-driven resonance tuning, among other features, and, in some examples, adjusts dynamically based on hardware-specific error profiles. Execution parameters are modified at runtime based on modeled fields, not hardwired behavior. For example, the modulation engine 104 identifies the hardware platform and determines an error profile that is appropriate for the identified hardware. As such, the modulation engine 104 is simple and cost-effective to incorporate into or add to existing computing infrastructures.

The coherence tuning framework operates as a control-layer architecture and may be implemented in hardware, firmware, middleware, or distributed computational platforms.

For example, at least a portion of the modulation engine 104 is implemented in different layers and/or components of the computing system 100 or auxiliary systems. For example, the modulation engine 104 may be implemented in an execution layer that interacts directly with circuits. In one example, the modulation engine 104 utilizes hardware-embedded execution logic (e.g., field programmable gate arrays, application-specific integrated circuits, etc.) to process instructions. In another example, the modulation engine 104 is included on a self-contained control unit that pre-processes and optimizes execution without interfacing with external middleware. In some examples, aspects of the modulation engine 104 are incorporated into an on-chip control system that executes, optimizes, and stabilizes circuits. Such embodiments may operate without interfacing with middleware or requiring input from external sources.

Alternatively, at least some aspects of the modulation engine 104 are incorporated into offboard sources (e.g., cloud-based systems). For example, aspects of the modulation engine 104 may utilize cloud-based execution services that process and optimize tasks externally before sending instructions to hardware.

Also, the modulation engine 104 may rely on networked execution systems in which distributed nodes collaborate in execution without needing middleware coordination. In addition, a protocol for the modulation engine 104 may optimize and schedule jobs before they reach the processors 102.

In examples, aspects of the modulation engine 104 are implemented in various stages of processing and pre-processing bit operations. Also, the modulation engine 104 may use real-time feedback or tracking built into the execution layer. Further, the modulation engine 104 may implement vacuum energy field stabilization techniques controlled directly by the execution layer.

Execution of the computing system 100 may be decentralized across multiple systems. For example, a blockchain-based execution layer may optimize and validate computations in a distributed network. Also, the computing system 100 may utilize peer-to-peer job execution and leverage execution-level consensus mechanisms. In other examples, the computing system 100 creates a tokenized execution framework that assigns tasks dynamically without a centralized system.

The computing system 100 may have a networking stack where execution synchronization occurs in any layer. In other examples, the computing system 100 may have a network or device-based execution system.

The computing system 100 may include one or more communication systems that enable communication by and between components of the computing system 100 and/or facilitate or otherwise enable the computing system 100 to communicate with remote computing devices. Examples of suitable communication connections include, but are not limited to, radio frequency (RF) transmitter, receiver, and/or transceiver circuitry, and/or universal serial bus (USB), parallel, and/or serial ports. Communication systems may also comprise physical ports (i.e., ethernet or fiber optic) or wireless antenna and supporting hardware which enable the computing system 100 to send or receive data over an internet connection. The communication systems may include a network that is wired and/or wireless and utilizes any suitable communication protocols including, but not limited to, internet, cellular, Wi-Fi, Bluetooth, near-field communication, or other wireless (or wired) communication protocols.

The modulation engine 104 identifies and models a vacuum energy field 124 associated with an element 120 and operates the modulation device 106 to manipulate the vacuum energy fields 124 around the element 120 using, for example, software-defined flux energy execution modeling. The vacuum energy field 124 may encompass, for example, a coherent electromagnetic field including vacuum energy around the element 120. The vacuum energy fields 124 are structured by applying the modulation field via the modulation device 106. In addition, in some examples, the modulation engine 104 manipulates the vacuum energy fields 124 in real time by dynamically tuning, for example, the execution parameters of a circuit to compensate for energy fluctuations. The vacuum energy fields 124 remain structured during operations and prevent distortion due to the operations of the modulation engine 104. For example, the modulation engine 104 is configured to selectively control gates based on the vacuum energy fields 124 around the element 120 to modulate the element 120.

In some examples, the modulation engine 104 determines an operating status of each element 120 and/or the system 100 or a predicted operating status of each element 120 and/or the system 100 before the modulation field is applied to the vacuum energy field 124. The modulation engine 104 then operates the modulation device 106 to manipulate the vacuum energy fields 124 based on the operating status of the element 120 and/or the system 100 or the predicted operating status of the element 120 and/or the system 100. The modulation engine 104 alters the determined operating status of the element 120 and/or the system 100 and/or causes the element 120 and/or the system 100 to arrive at a predicted operating status based on the modulation field.

The modulation engine 104 includes an artificial intelligence (AI) module 126 that is configured to determine operating parameters of the system 100 in real-time to further improve performance of the system 100. In the example, the AI module 126 includes a generative AI platform designed to synthesize novel data or solutions based on learned patterns and constraints. Additionally or alternatively, the AI module 126 may employ any suitable AI platform(s). The specific AI platform(s) employed within the AI module 126 can be dynamically selected or combined based on the requirements of the processor 102, the nature of the input data, and the desired output characteristics. Examples of AI platforms that may be included in the AI module 126 include, without limitation, machine learning, neural networks, reinforcement learning, symbolic AI, hybrid AI platforms, and/or any other AI platforms. Further, the AI module 126 could be implemented using custom-designed AI platforms, tailored to the specific requirements of the modulation engine 104 and/or the modulation device 106.

The AI module 126 of the modulation engine 104 facilitates the modulation engine 104 dynamically adjusting the modulation device 106 in real time to improve performance of a system incorporating the element 120. For example, the AI module 126 continuously refines the modulation field delivered by the modulation device 106 based on real-time execution feedback to improve overall stability.

The AI module 126 of the modulation engine 104 employs optimization algorithms, such as genetic algorithms, gradient descent, or particle swarm optimization, to explore the design space of software-driven modifications. Machine learning techniques, such as reinforcement learning or supervised learning, are incorporated to refine optimization strategies based on the modeled vacuum energy fields. The modulation engine 104 generates optimized software parameters, which are then validated through further modeling, to ensure compliance with performance and reliability specifications.

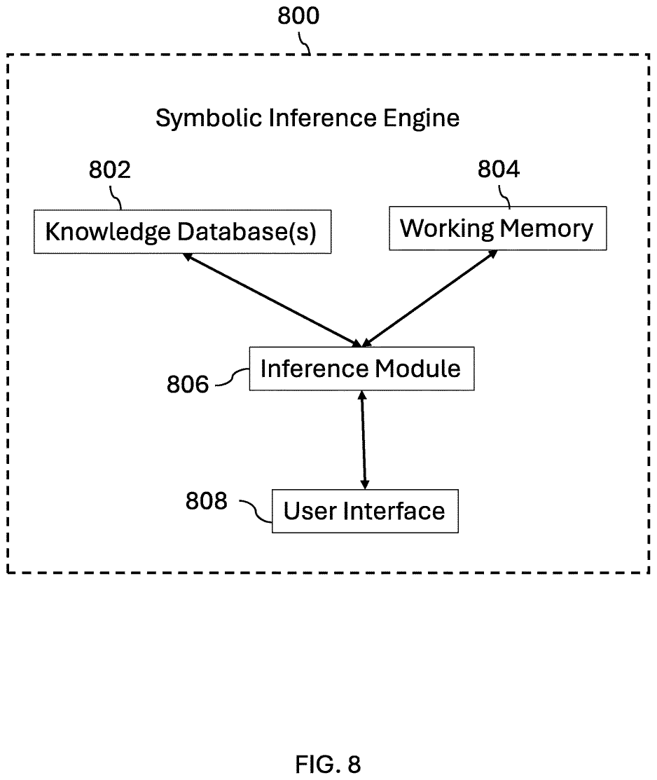

The AI module 126 includes a prediction unit and/or an inference engine such as the symbolic inference engine 800 shown in FIG. 8. For example, the AI module 126 runs simulations based on the vacuum energy field 124 and/or the possible operating parameters of the element 120 and/or the system 100. The AI module 126 calculates the possible structured vacuum energy outputs and selects the modulation field that provides a desired characteristic or operating parameter of the element 120 and/or the system 100.

The AI module 126 utilizes any suitable training database. For example, the AI module 126 may be trained using a database of physics principles, equations and algorithms described herein, and any other suitable information. In addition or alternatively, the AI module 126 may utilize machine learning. For example, the AI module 126 may store, evaluate, and learn from operations modeled and/or implemented during operation. The AI module 126 may compare parameters for different models based on the vacuum energy field information received from modules and select optimal structures based on the comparison. For example, the AI module 126 can utilize an inference model including predictive analytics and decision making. In addition, the AI module 126 can utilize feedback-based adaptive correction, and/or reinforcement learning.

While AI-based optimization may refine modulation parameters, other examples do not require predictive restructuring of execution pathways. Instead, parameter adjustment is driven, for example, by calculated coherence amplitudes.

In examples, the system 100 utilizes special-purpose machines and components that are designed and constructed for manipulating vacuum energy fields. For example, the components are free of shielding (e.g., electromagnetic shielding) that would inhibit the manipulation fields interacting with the vacuum energy fields in at least the section around the element(s) 120. Specifically, there is no shielding in the system 100 between the modulation device 106 and the vacuum energy field 124 associated with the element 120.

In the example, the computing system 100 includes a tensor control engine 103. The tensor control engine 103 is a module or a combination of modules implemented in hardware and/or software that monitors signal parameters and adjusts parameters of the processor 102. For example, the tensor control engine 103 can be implemented via electronic circuitry, firmware, and/or software instructions executed by a microcontroller, that perform the functions of the tensor control engine 103. The tensor control engine 103 operates the processor 102 to facilitate, for example, runtime optimization, learned injection logic, and/or hardware-agnostic scheduling with calibration independence. For example, the tensor control engine 103 is configured to initialize an execution cycle, compute a refresh factor, determine tensor curvature according to matrix weighting, calculate injection strength, inject operations based on the injection strength, apply a conditional control logic, modulate a bias, and/or output a graph or circuit. In other examples, the tensor control engine 103 is omitted.

The tensor control engine 103 is configured to modulate operations involving at least one tensor. The term ‘tensor’ refers to a multi-dimensional array of data, such as numerical data. For example, tensors generalize scalars (0-dimensional tensors), vectors (1-dimensional tensors), and matrices (2-dimensional tensors) to an arbitrary number of dimensions. Each element within a tensor is typically identified by a set of indices corresponding to its position along each dimension.

Also, the tensor control engine 103 is configured to modulate tensors according to an injection strength. The term “injection strength” refers to a controllable parameter that quantifies the magnitude, intensity, or frequency of a modification signal or data alteration being introduced into a tensor or a tensor processing workflow. The modification may be applied to the tensor data itself, to the operational parameters governing its processing, or to the computational environment. The injection strength is dynamically adjustable by the tensor control engine 103 to achieve a desired outcome, such as enhancing model robustness, evaluating system resilience, or influencing the behavior of a computational process.

In one example, the tensor control engine 103 utilizes the injection strength as a mechanism for data augmentation and model regularization, particularly in machine learning applications. In this context, the tensor control engine 103 uses the injection strength to dictate the magnitude of artificial perturbations or noise introduced into the input tensors during a training process. For example, the tensor control engine 103 can be configured to inject random noise into the tensors, and the injection strength corresponds to a statistical property of the noise, such as a standard deviation or maximum amplitude. A higher injection strength would introduce more significant noise, compelling the machine learning model to learn more robust and generalizable features. In such examples, the tensor control engine 103 uses the injection strength to prevent overfitting. The tensor control engine 103 dynamically varies the injection strength throughout the training cycle, for instance, by applying a high injection strength during initial epochs and gradually decreasing the injection strength for fine-tuning as the model converges.

In another example, the tensor control engine 103 employs injection strength to evaluate the resilience and fault tolerance of a tensor processing system. Here, the tensor control engine 103 acts as a fault injector, and the injection strength determines the severity or frequency of the introduced faults. These faults can simulate a range of real-world hardware or software errors, such as bit-flips in memory (single-event upsets), numerical precision errors, or dropped data packets. The tensor control engine 103 uses the injection strength to represent the probability of a bit-flip occurring in a tensor element, the numerical magnitude of an error added to a specific value, or the rate at which operations are intentionally corrupted or skipped. By systematically adjusting the injection strength, the tensor control engine 103 facilitates and/or performs stress tests to identify system vulnerabilities and quantify the robustness of the computational pipeline under various adverse conditions.

In a further example, the tensor control engine 103 utilizes the injection strength relative to an amplitude or power of an external signal deliberately introduced to influence or analyze the system's dynamic behavior. The tensor control engine 103 injects a defined signal-such as a specific data pattern, a bias value, or a control signal-into the tensor data stream or into the parameters of the computational graph. The injection strength governs the extent to which this signal influences the downstream operations and ultimate output. For example, in a control systems application, the tensor control engine 103 uses the injection strength to control the weight of a corrective signal designed to steer the system towards a desired state. Alternatively, for system analysis applications, the tensor control engine 103 uses a signal with a defined injection strength to probe the system's response and measure transfer functions or identify dynamic characteristics of the tensor processing workflow in real-time.

The tensor control engine 103 uses parameters or tensor characteristics, such as tensor curvature, to dynamically define the injection strength. As used herein, the term “tensor curvature” refers to a computed metric that quantifies the relational, topological, or symbolic relationship between nodes within a tensor graph or circuit. In an example, the tensor curvature is determined by a matrix weighting factor, which can be explicitly provided as a symbolic matrix (M) or functionally approximated through other means if a matrix is not provided. The tensor control engine 103 uses the tensor curvature as an input for modulating operations, enabling curvature-weighted adjustments to the system's behavior. The tensor control engine 103 uses the tensor curvature to facilitate structure-aware execution control and feedback-aware topological shaping and improves performance beyond static transformation orders.

In an example, the tensor control engine 103 defines the tensor curvature based on a provided symbolic matrix (M). For example, the matrix M encapsulates the desired relational weights or symbolic dependencies between any two nodes, i and i+1, in an execution graph. The curvature value is derived directly from the corresponding element in the matrix M, and is clipped to a predefined range to ensure stability. For example, the tensor control engine 103 uses this approach in systems where a high-level symbolic controller or a pre-computed model provides guidance on how the graph's topology should be shaped. For example, in a neural-symbolic controller, the matrix M could represent a learned policy for modulating connections within a neural network. Accordingly, the tensor control engine 103 uses the tensor curvature to facilitate dynamic, curvature-guided reshaping of the inference graph.

In another example, applicable when a symbolic matrix may not be provided, the tensor control engine 103 determines the tensor curvature using a heuristic or an intrinsic property of the system. For example, the tensor control engine 103 determines the tensor curvature as a function of the dimensional distance between nodes within the tensor structure. This method allows the tensor control engine 103 to operate without external guidance, relying instead on the inherent topology of the circuit or graph. For example, the tensor control engine 103 may use this approach in environments like Field-Programmable Gate Arrays (FPGAs) or Digital Signal Processors (DSPs). The tensor control engine 103 modulates gate scheduling or filter taps based on their logical proximity and provides a baseline for coherence-aware optimization without requiring a complex external model.

In a further example, the tensor control engine 103 applies the tensor curvature as a node-local modulation scalar, or bias. This form of curvature, bias, is derived from the diagonal elements of a symbolic matrix, Mq,q, representing a node's self-interaction or intrinsic importance. The bias allows for per-node bias modulation, which can be applied to dynamically adjust the operating point of individual components in a system. For instance, in an analog signal path, the tensor control engine 103 uses the curvature-derived bias to modulate the logic level or gain of a specific circuit element. Similarly, in a quantum processing unit (QPU), the tensor control engine 103 uses the bias to fine-tune the resting state or phase of an individual qubit to enhance coherence or fidelity as part of the overall optimization strategy. If no matrix is provided, the tensor control engine 103 uses a default scalar value and ensures baseline stability. In some examples, scalar constants are illustrative and calibrations may vary across backends.

During operation, the tensor control engine 103 calculates one or more parameters or tensor characteristics to provide a dynamically tuned injection operation or tensor modulation for a computer operation. For example, the tensor control engine 103 calculates at least one of a cycle-scaled refresh factor, a curvature-weighted injection strength, a tensor gate strength, a conditional logic, and/or a per-node bias modulation.

For example, the tensor control engine 103 calculates a refresh factor according to Equation (7).

$$R = 0.045 + 0.06 * log ( 1 + C ) \qquad Equation ( 7 )$$

where C represents an execution cycle (entropy, time, state, etc.) and R represents a refresh factor modulated by C.

A tensor curvature weight (W) is defined as the curvature or weight between nodes in a tensor graph or circuit. The tensor curvature weight (W) is a calculated metric that quantifies the symbolic or topological relationship between different points in the system.

For example, the tensor control engine 103 calculates the tensor curvature based on a curvature-weighted strength function represented by Equation (8) if a matrix M is provided or Equation (3) if matrix M is not provided.

$${W}_{i , i + 1} = clip ( {M}_{i , i + 1} , 0.01 , 1 \text{.0} ) \qquad Equation ( 8 )$$

$${W}_{i , i + 1} = 1 + 0.025 * \frac{\vert i - ( i + 1 ) \vert}{dim} \qquad Equation ( 9 )$$

where W_{i,i+1} represents the curvature/weight between nodes i and i+1, where i represents the index of the node being processed, and M represents a provided symbolic matrix or functional approximation.

The functional range of W is determined by the two cases outlined in Equations (8) and (9). When matrix (M) is provided, the value of tensor curvature (W) is derived from the matrix element and constrained by a clipping function, e.g., clip (M, 0.01, 1.0). Accordingly, when matrix (M) is provided, the value of tensor curvature (W) is within the range of [0.01, 1.0]. When matrix (M) is not provided, the value of tensor curvature (W) is calculated according to Equation (9). Accordingly, Equation (9) sets the functional range for tensor curvature (W) when matrix (M) is not provided. Since the numerator |i−(i+1)| is 1 and the dimension dim is a positive integer, the second term is a small positive value. For example, if dim is 1, W would be 1.025. As the dimension increases, the value of tensor curvature (W) approaches 1, or as the dimension decreases, the value of tensor curvature (W) increases. The equations or outputs may be modified to provide a determined functional range. For example, the variables such as the dimension value (dim) could be constrained in a range of 0.025 to 1 and set to increase or decrease as desired. In an example, the tensor curvature (W) may have a functional real-world range such as a range from 0.01 to 2.

In the example, the dimension variable (dim) represents a scalar value that may characterize a structural property or a normalizing factor of the tensor graph, circuit, or data structure being processed. For example, the dimension variable provides a measure of the overall size, complexity, or dimensionality of the operational context. The specific quantity represented by the dimension variable is dependent on the application domain. For example, the dimension variable may represent, without limitation, a total number of nodes, vertices, or qubits in a computational graph or quantum circuit; a rank (i.e., the number of dimensions) of an input tensor; a size of a specific, relevant dimension of the input tensor; a key hyperparameter of a neural network, such as the number of layers or the total number of features; or a diameter of a computational graph, defined as the longest shortest path between any two nodes. By serving as a denominator in the heuristic formula of Equation (9), the dimension variable (dim) acts as a normalizing factor and scales the calculated weight based on the overall structural characteristics of the system when an explicit symbolic matrix (M) is not provided.

The tensor control engine 103 calculates an injection strength, e.g., a tensor gate strength, according to Equation (10).

$${S}_{i , i + 1} = R * {W}_{i , i + 1} \qquad Equation ( 10 )$$

where S_{i,i+1} represents a tensor strength or modulation, R represents a refresh factor, and W_{i,i+1} represents a curvature/weight between nodes i and i+1.

Optionally, the tensor control engine 103 applies conditional control logic. For example, the tensor control engine 103 determines a conditional value (CV) according to Equation (11).

$$CV = ( i + ⌊ 8 \cdot W ⌋ ) mod 2 \qquad Equation ( 11 )$$

where CV represents the conditional value and W represents weight.

According to an example of the conditional control logic, if the conditional value is equal to zero or another preselected value, then the symbolic control operation is injected. The symbolic control operation may not be injected if the conditional value is other than zero. The tensor control engine 103 may continually calculate the conditional value and input the symbolic control operation based on the tensor strength when the conditional value is zero. In other examples, the conditional control logic may operate to inject operations when the conditional value is a preselected value other than zero. In further examples, the tensor control engine 103 does not apply conditional control logic and injects operations according to calculated values unconditionally.

Also, in some examples, the tensor control engine 103 calculates a per-node bias modulation according to Equation (12) if a matrix M is provided.

$${bias}_{q} = clip ( {M}_{q , q} , 0.005 , 0.05 ) \qquad Equation ( 12 )$$

where bias_{q} represents a node-local modulation scalar, and M_{q,q} represents a provided matrix.

If matrix M is not provided, the tensor control engine 103 substitutes a predetermined value (e.g., 0.041) for the bias modulation.

Accordingly, in operation, the tensor control engine 103 acts as a dynamic tensor controller that injects operations as a function of execution cycle, curvature metric, and optional symbolic matrix. For example, the execution cycle, curvature metric, and optional symbolic matrix are calculated per equations (6)-(12) and modulate symbolic transformations across quantum, neural, or classical substrates.

The term “execution cycle” (C) refers to a quantitative, abstract metric representing the state, time, or progression of a computational process. The execution cycle is not limited to a simple counter or clock tick, but rather serves as a dynamic, structure-aware input that allows the tensor control engine 103 to modulate operations over the evolution of a system. The specific physical or logical quantity represented by the execution cycle is dependent on the operational domain. For example, the execution cycle may represent a measure of time, system state, or entropy; a phase angle or quantum entropy index in a quantum system, a timing of a neural spike in a neural computation platform; or a measure of energy flux in an analog or physical system.

The tensor control engine 103 uses the value of the execution cycle (C) as a direct input to calculate a cycle-scaled refresh factor (R), which in turn modifies the dynamic injection strength of a given operation. As a result, the tensor control engine 103 facilitates a system's behavior being responsive to progress of system operations, whether that progress is measured in steps, time, entropy, or another relevant domain-specific metric.

The tensor control engine 103 operates across domains, including, for example and without limitation, classical, supercomputing, or hybrid circuit optimization, neural network reshaping, tensor graph inference control, DSP/FPGA gate scheduling, secure entropy-aware computation, analog signal logic modulation, symbolic compiler transformation passes, and temporal spike-based modulation in analog systems. The tensor control engine 103 is deployable across classical tensor networks, FPGA/ASIC logic, symbolic AI compilers, software development kits (SDKs), and hybrid execution platforms. Also, the tensor control engine 103 is compatible with runtime metrics (entropy, time, energy) for feedback-controlled modulation, abstracts gates as symbolic operations for analog, neural, or quantum domains, enables secure compute masking and coherence-aware execution, and is adaptive to backend constraints, including coherence loss, fidelity drift, or scheduling bottlenecks.

For example, when integrated with a compiler, the tensor control engine 103 may provide the injection strength S as a parameter to a dedicated compiler pass. The compiler uses the provided injection strength to select one of several available graph rewrite rules.

The symbolic matrices (M) are a data structure, or a functional approximation of a data structure, that serves as an optional input to the tensor control engine 103. The matrices (M) provide relational, topological, or symbolic information that the tensor control engine 103 uses to determine the curvature-weighted strength function (W) and the per-node bias modulation (bias_{q}). For example, the elements of each matrix represent learned or defined relationships between nodes in a tensor graph or circuit. For example, an off-diagonal element Mi,i+1 provides a weight between nodes i and i+1, while a diagonal element Mq,q provides a node-local scalar for self-interaction or bias. The matrices (M) allow the tensor control engine 103 to generate injection logic that is guided by an external, structure-aware policy. In some examples, one or more of the matrices (M) are not provided or used and the tensor control engine 103 provides default-mode behavior with entropy-index fallback.

An expected domain for the matrix (M) can be inferred from sources including, but not limited to, reinforcement learning agents, self-supervised agents, entropy-guided policies, transformer architectures, and/or neural ensemble controllers. Accordingly, the matrix (M) represents a dynamically learned policy rather than a static configuration and facilitates the tensor control engine 103 adapting behavior based on complex patterns and feedback loops identified by sophisticated architectures. In an example utilizing reinforcement learning, a state may be defined by the current tensor characteristics and resource map, an action may be the selection of a symbolic matrix M from a set of candidate matrices, and a reward may be based on the resulting computational throughput and fidelity. The learned policy thus maps a given system state to an optimal matrix M for guiding the injection logic.

In some examples, the tensor control engine 103 includes injection logic that adapts dynamically using entropy traces, temporal indices, or coherence metrics. The logic of the tensor control engine 103 executes on GPU, TPU, FPGA, DSP, QPU, analog, or neural-symbolic substrates. Injection operations include symbolic gates, analog signals, compiler passes, DSP filters, and/or graph rewrites. The symbolic logic may be inferred from reinforcement learning, self-supervised agents, entropy-guided policies, transformer architectures, and/or neural ensemble controllers. The cycle may be substituted by phase angle, quantum entropy index, neural spike timing, and/or energy flux.

In some examples, the tensor control engine 103 performs a gate injection that forms a dynamic tensor graph whose connectivity evolves based on curvature, state, and/or symbolic controller input.

The tensor control engine 103 is configured to be used in different systems. For example, the tensor control engine 103 is configured to facilitate neural encoder weights modulated via symbolic feedback curvature, analog DSP circuits dynamically biased via entropy-phase cycles, reinforcement-learned topology reshaping in inference graphs, and FPGA control logic restructured through runtime symbolic signal reshaping. Any symbolic, neural, compiled, analog, quantum, or firmware-equivalent implementation is within the scope of this disclosure.

In some examples, the tensor control engine 103 is generally hardware agnostic and is compatible with a broad range of computing architectures, including superconducting bit platforms and any processing units.

In some examples, the system 100 includes a basis-dependent coherence preservation engine 107. For example, the basis-dependent coherence preservation engine 107 is programmed to measure a state tomography of a processing unit (e.g., the element 120) based in the Z-axis. For example, the state tomographies are performed to measure off-diagonal elements of a density matrix in the Z-axis. In other examples, the basis-dependent coherence preservation engine 107 is programmed to measure data integrity or information stability of the processing unit based in the Z-axis. The coherence value is suppressed in the state based in the Z-axis.

The basis-dependent preservation engine 107 determines gate operators to rotate the processing unit in the X-axis and the Y-axis based on the state tomography measured in the Z-axis and rotates the processing unit in the X-axis and the Y-axis by applying the gate operators. For example, a Hadamard gate may be used to rotate the processing unit on the X-axis and a combination of a S-dagger and Hadamard gate(s) may be used to rotate the processing unit on the Y-axis. The operator(s) may be represented as unitary operators that change a measurement basis from a computation basis (e.g., the Z-axis) to an alternative Pauli basis (e.g., the X or Y-axis) or represented as error resilience based on coding theory (e.g., Hamming distance, syndrome decoding efficiency). In some examples, the basis-dependent coherence preservation engine 107 is programmed to execute the operation on the system 100 with the processing unit rotated according to the gate operators.

After rotation of the processing unit, the basis-dependent coherence preservation engine 107 is programmed to measure a state tomography of the processing unit based in the X-axis and/or the Y-axis, and determine a coherence value of the processing unit based on the state tomography. In contrast to the state tomograph in the Z-axis which displays suppressed coherence, the state tomography of the processing unit based in the X-axis and/or the Y-axis may be quantified as slow-decay meaning coherence is preserved for a longer period than in the Z-axis.

The coherence value may be determined using a basis-contrast witness that is a function of the total variation distance between the probability distributions in the Z-basis and at least one of the X-axis or Y-axis. In some examples, the coherence value is determined using an entropy-drop proxy, where the coherence is determined as a function of the Shannon entropy of the probability distributions in the X-axis or Y-axis relative to a maximum possible entropy.

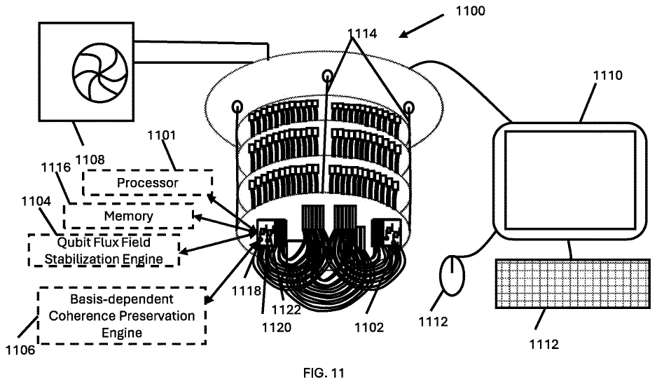

For example, the basis-dependent coherence preservation engine 107 may utilize any of the equations and methods described in relation to the basis-dependent coherence preservation engine 1106 shown in FIG. 11.

In some examples, the basis-dependent coherence preservation engine 107 utilizes a stored algorithm or equation to calculate a coherence value. In other examples, the coherence value is retrieved from a table or lookup based on information for the execution circuit. In further examples, the coherence value is provided to the basis-dependent coherence preservation engine 107.

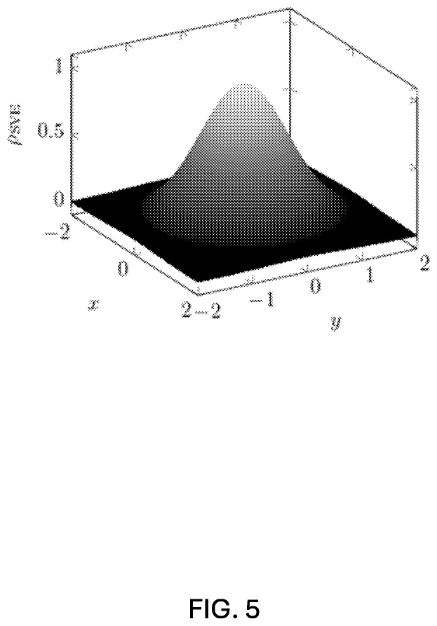

The basis-dependent coherence preservation engine 107 provides a software-defined execution framework that dynamically optimizes circuit execution by basis-dependent coherence preservation. In some examples, at least a portion of the basis-dependent coherence preservation engine 107 is incorporated into middleware that facilitates communication between an operating system and an application (as shown in FIG. 5). For example, the middleware is implemented as a software exception layer that sits between an application layer and a hardware layer. Suitably, the basis-dependent coherence preservation engine 107 is not bound to physical hardware but is compatible with different hardware to function as a transpilation, optimization, and/or execution enhancement middleware. In other examples, the basis-dependent coherence preservation engine 107 is incorporated into a standalone application, an operating system, and/or any suitable platform. In some examples, operations of the basis-dependent coherence preservation engine 107 are divided across middleware and execution level controls and/or are implemented in tightly integrated middleware and execution control packages. In further examples, the basis-dependent coherence preservation engine 107 is not included in or does not interact with middleware.

The basis-dependent coherence preservation engine 107 can be implemented in a classical hardware platform like a Field-Programmable Gate Array (FPGA) or an Application-Specific Integrated Circuit (ASIC). For example, the basis-dependent coherence preservation engine 107 first measures the state of a processing unit (e.g., a critical data register) in a primary (Z) state, where the critical data register exhibits high error susceptibility due to anisotropic decay rates. The information's integrity value is thus determined to be at or below a suppressed threshold. The basis-dependent coherence preservation engine 107 then performs BDCP-aware transpilation by determining and selecting appropriate data transformation logic (gate operators) such as an Error-Correcting Code (ECC) scheme. This transformation logic is applied to modify a parameter of the processing unit, effectively basis-routing the information into a more stable X or Y representation (the slow-decay axes). Finally, the basis-dependent coherence preservation engine 107 measures the information in this transformed state and confirms that a coherence value (e.g., the integrity value) exceeds the suppressed threshold, demonstrating that the method enhances information coherence in distributed systems that would otherwise be lost in the vulnerable Z-state.

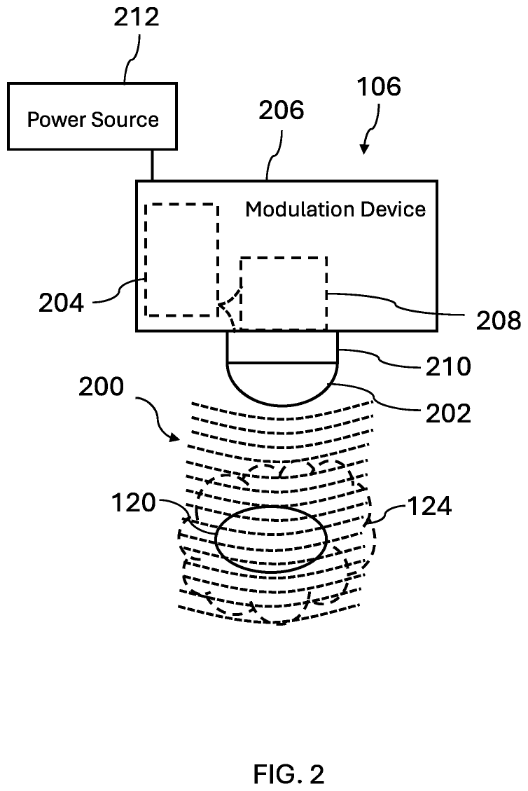

FIG. 2 is a partially schematic diagram of an example of the modulation device 106 configured to deliver the modulation field 200 to the element 120. The modulation device 106 includes any mechanism that is capable of delivering a modulation field to the element 120. For example, the modulation device 106 includes, without limitation, a light source, an energy source, a vacuum generator, a heater, a signal transmitter, and/or a speaker.

In the example illustrated in FIG. 2, the modulation device 106 includes a field generator 208, a regulator 210, an emitter 202, a controller 204, and a housing 206. The housing 206 at least partly encloses and/or supports the field generator 208, the regulator 210, the emitter 202, and the controller 204. For example, the housing 206 provides physical support and environmental protection for the other components of the modulation device 106. In some examples, the housing 206 shields the device from external interference and/or facilitates directing the modulation field 200. For example, and without limitation, the housing 206 may include a plastic or metal enclosure, a vacuum chamber, and/or a waveguide structure to contain and direct electromagnetic waves. For example, if the modulation device 106 is configured to apply topological modulation, the housing 206 may maintain a specific temperature or pressure required for the topological phase of the material, include integrated waveguides or optical elements that efficiently couple to and extract the modulated field from the topological material, and/or provide shielding against magnetic fields that could disrupt the topological states. The housing 206 is free of any shielding that would extend between the emitter 202 and the target.

The emitter 202 is configured to introduce or launch the field for modulation. The emitter 202 is selected based on the type of field being modulated. For example, for an electromagnetic field, the emitter 202 may include an antenna (for radio waves), a laser diode (for light), a microwave horn (for microwaves), and/or a cascade laser (for terahertz radiation). For acoustic waves, the emitter 202 may include a piezoelectric transducer, a MEMS speaker, and/or an ultrasonic transducer. For a spin wave (Magnonic), the emitter 202 may include a microstrip antenna or a spin-orbit torque (SOT) device used to excite magnons in a magnetic material. For a topological modulator, the emitter 202 includes mechanisms configured to excite topologically protected modes or edge states within the modulator material, such as a specifically patterned antenna designed to couple to chiral edge states in a topological insulator at a particular frequency, and/or a focused laser beam configured to excite specific topological excitations (e.g., skyrmions or domain walls) in a topological magnetic material.

The field generator 208 creates the initial energy or excitation that the emitter 202 shapes into the field to be modulated. In some cases, the emitter 202 and the field generator 208 are integrated into a single component. In examples, the field generator 208 may include electromagnetic waves, an oscillator circuit that produces a specific frequency signal, and/or a current source driving an antenna. For acoustic waves, the field generator 208 may include an oscillating voltage source applied to a piezoelectric crystal. For a spin wave, the field generator 208 may include a microwave source providing the initial energy to excite magnons. For a topological modulator, the field generator may include a precisely controlled current source designed to inject spin-polarized electrons into a topological insulator to excite specific spin textures and/or a laser with a specific wavelength and polarization chosen to efficiently excite quasiparticles in a topological superconductor.

The controller 204 includes one or more processors that act as the central processing unit of the modulation device 106. The controller 204 receives input signals (e.g., electrical control voltages, optical signals, digital commands) and sends the necessary control signals to the regulator 210 and potentially the field generator 208 and the emitter 202. The controller 204 communicates with external components, determines (e.g., calculates or receives) parameters such as the modulation factors and/or the structured vacuum energy output, and dictates the nature and timing of the modulation applied to the field. For example, the controller 204 includes a microcontroller or FPGA (Field-Programmable Gate Array) executing a modulation algorithm, analog circuitry that generates control waveforms (e.g., sinusoidal, square, pulsed), and/or a digital signal processor (DSP) implementing complex modulation schemes.

The regulator 210 directly interacts with the field generated by the emitter 202 and modifies the properties of the field according to the control signals received from the controller 204. The regulator 210 is selected based on the type of fields that are manipulated. For example, for electromagnetic fields, the regulator 210 may include a variable attenuator (for amplitude modulation), a phase shifter (for phase modulation), a polarizer (for polarization modulation), and/or a voltage-controlled oscillator (for frequency modulation). For acoustic systems, the regulator 210 may include a variable acoustic impedance element and/or an array of transducers with individually controlled phases (for beam steering and shaping). For a spin wave, the regulator 210 may include a gate electrode applying an electric field to modify the magnetic properties and thus the spin wave propagation, and/or a patterned magnetic layer creating a potential landscape for magnons. For a topological modulation field, the regulator 210 may include a gate electrode fabricated on a topological insulator to electrostatically control the Fermi level and thus the conductivity of the surface states, a patterned magnetic layer placed near a topological superconductor to induce and manipulate Majorana bound states, and/or an optical beam used to locally heat or excite a topological material to alter a topological phase or the properties of edge states and modulate the transmission of another signal.

In the example, the modulation device 106 is connected to a power source 212. The power source 212 may be any suitable power source. In some examples, the power source 212 is a battery mounted on the modulation device 106 and/or an external power supply, and the power source 212 is configured to deliver electrical power. In other examples, the power source 212 delivers power for the modulation device 106 utilizing any suitable fuel. In some examples, the modulation device 106 (and/or the system 100 shown in FIG. 1) derives at least some power from the structured vacuum energy fields. For example, the modulation fields 200 from the modulation device 106 may be delivered to the field to structure the field in such a manner that the structured vacuum energy output includes energy that is released or extracted from the vacuum energy field and used to charge a battery of the power source 212 and/or directly power components such as the modulation device 106 and/or external systems. In some examples, structured field outputs may influence system power efficiency or internal energy redistribution.

During operation, the modulation device 106 delivers the modulation field 200 to the element 120 when power is supplied to the emitter 202. For example, the field generator 208 generates the modulation field 200 when supplied with power. The regulator 210 adjusts the modulation field 200 according to the calculated modulation factor to reach the determined structured vacuum energy output and/or according to modeled coherence amplitude to tune or modulate the coherence of the element 120. The emitter 202 discharges the modulation field and directs the modulation field toward the element 120. The modulation field 200 interacts with the vacuum energy field 124 of the element 120 and modifies the vacuum energy field 124 into a structured pattern according to the structured vacuum energy output. For example, the modulation field 200 reduces coherence loss of the element 120.

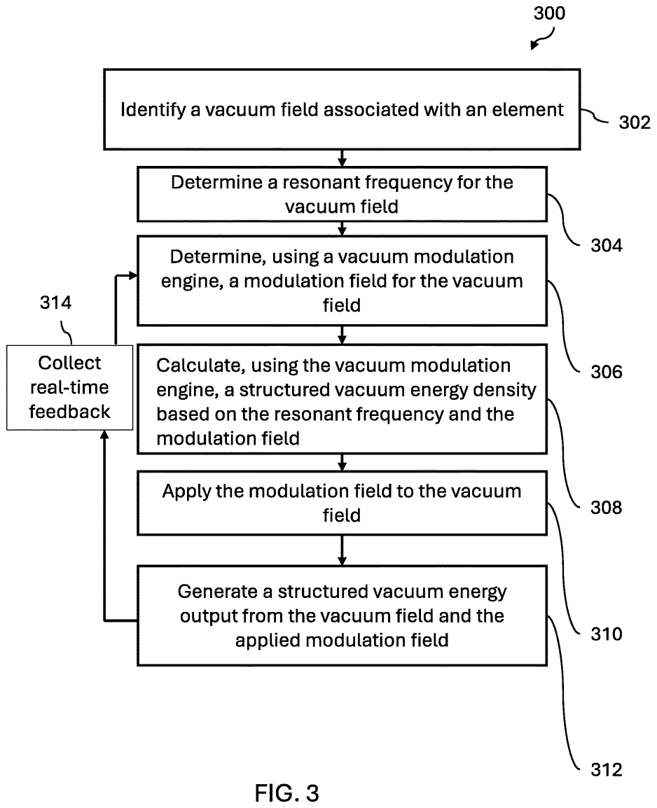

FIG. 3 is a flow diagram of an example method 300 for generating a structured vacuum energy field (e.g., the vacuum energy field 124 shown in FIG. 1) associated with an element (e.g., the element 120 shown in FIG. 1) to regulate operating parameters of the element. For example, a non-transitory computer-readable medium stores instructions that, when executed by a processor, cause the processor to perform the method 300.

Referring to FIGS. 1-3, in the method 300, a vacuum modulation engine (e.g., the modulation engine 104) identifies 302 a vacuum energy field (e.g., the vacuum energy field 124) associated with an element (e.g., the element 120). For example, the vacuum modulation engine utilizes a computational model that simulates a structured vacuum energy field for the element 120 based on characteristics of the element 120 provided by feedback sensors, received from an external input, and/or retrieved by the vacuum modulation engine from a database.

The vacuum modulation engine determines 304 a resonant frequency for the vacuum energy field. For example, the vacuum modulation engine calculates the resonant frequency based on information about the element and/or a model of the element; the vacuum modulation engine receives the resonant frequency from an external input, and/or the vacuum modulation engine retrieves the resonant frequency from a database.

The vacuum modulation engine determines 306 a modulation field for the vacuum energy field. For example, the vacuum modulation engine uses any of equations (1)-(6) to calculate the modulation field; the vacuum modulation engine receives the modulation field from an external input, and/or the vacuum modulation engine retrieves the modulation field from a database.

Based on the resonant frequency and the modulation field, the vacuum modulation engine calculates 308 the structured vacuum energy density. For example, the vacuum modulation engine uses any of equations (1)-(6) to calculate the structured vacuum energy density. For example, the structured vacuum energy density is calculated by multiplying the reduced Planck constant and the resonant frequency and dividing the product of the reduced Planck constant and the resonant frequency by the product of the speed of light to the third power and a square of 2π.

A modulation device (e.g., the modulation device 106 shown in FIG. 1 or 2) applies 310 the modulation field to the vacuum energy field. For example, the modulation device emits a field modulated in accordance with determinations of the vacuum modulation engine. In examples, the modulated field is a continuous or discrete field. In further examples, the modulated field has a time characteristic and is time-dependent. In other examples, the modulated field is static. The modulated field may be modulated over spacetime, frequency, momentum, and/or symbolic domains.

In the method 300, the application of the modulation field to the vacuum energy field generates 312 a structured vacuum energy output. The structured vacuum energy output is structured to modify an operating parameter of the element and/or any system influenced by the element of the structured vacuum energy field. For example, the structured vacuum energy output may be employed to regulate at least one of energy density, entropy regulation, symbolic stability, logical propagation, physical structure, or information coherence of a system. In an example, the method 300 includes deterministically modulating, using a computational simulation platform, vacuum energy fields based on the structured vacuum energy density to generate coherent output states for symbolic or logical registers. In some examples, the modulation device acts according to the vacuum modulation engine to apply topological modulation using the modulation field to increase or suppress vacuum-mode coupling.

In some examples, the vacuum modulation engine determines vacuum energy fluctuations based on the structured vacuum energy output. For example, the vacuum modulation engine operates entropy-controlled logic gates using the vacuum energy fluctuations. The vacuum energy fluctuations are determined to provide a selected range of energy state transitions. In another example, the vacuum modulation engine processes data based on the vacuum energy fluctuations.

In examples, the vacuum modulation engine collects 314 real-time feedback before, during, and/or after application of the modulation field to the vacuum energy field. The real-time feedback facilitates precise tuning of the modulation field and instantaneous or preemptory corrections to the modulation field. The real-time feedback is collected 314 using sensors detecting operating parameters and/or based on results of computer modeling performed during operation of the system.

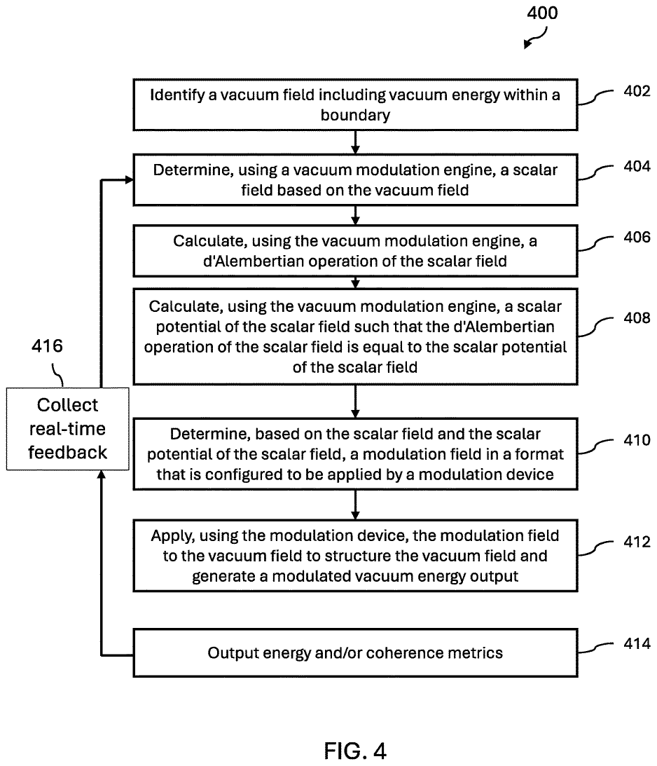

FIG. 4 is a flow diagram of an example method 400 for modulation of vacuum energy fields. For example, a non-transitory computer-readable medium stores instructions that, when executed by a processor, cause the processor to perform the method 400.

Referring to FIGS. 1, 2, and 4, in the method 400, a vacuum modulation engine (e.g., the modulation engine 104) identifies 402 a vacuum energy field (e.g., the vacuum energy field 124). For example, the vacuum energy field includes vacuum energy within a boundary. The vacuum modulation engine is implemented in at least one of a hardware, firmware, or symbolic platform.

The vacuum modulation engine determines 404 a scalar field based on the vacuum energy field. For example, the vacuum modulation engine calculates the scalar field, the vacuum modulation engine receives the scalar field from an external input, and/or the vacuum modulation engine retrieves the scalar field from a database. The vacuum modulation engine may use any of equations (1)-(6) and/or any other equations to calculate the modulation field.

Also in the method 400, the vacuum modulation engine calculates 406 a d'Alembertian operation of the scalar field. For example, the d'Alembertian operation is a mathematical tool that extends the idea of the Laplacian (which describes how a quantity changes in space) to spacetime, incorporating how that quantity changes with time in a way that is consistent with Einstein's theory of relativity and facilitates describing waves and fields in that framework.

In the method 400, the vacuum modulation engine calculates 408 a scalar potential of the scalar field such that the d'Alembertian operation of the scalar field is equal to the scalar potential of the scalar field. For example, if the scalar field is applied for adaptive tension modulation, the scalar field is calculated to satisfy the equation (5). In examples, a mathematical transformation is applied to the scalar field. Examples of the mathematical transformation include at least one of a mathematical operation, isomorphisms, domain substitutions, nonlinear embeddings, or variational parameterizations. The mathematical transformation may be used to replace the scalar field with an equivalent value that facilitates a different format of the computations or values.

The vacuum modulation engine determines 410, based on the scalar field and the scalar potential of the scalar field, a modulation field in a format that is configured to be applied by a modulation device. For example, the modulation field may include an electric current, a wave, light, sound, electromagnetism, vacuum energy, and/or any suitable field. In examples, the modulation field is represented by one of a scalar, a symbolic, tensorial, logical, topological, or algorithmic representation.

The modulation device applies 412 the modulation field to the vacuum energy field to structure the vacuum energy field and generate a structured vacuum energy output. For example, the modulation field is selected to cause entropy suppression, coherence retention, and symbolic propagation when the modulation field is applied to the vacuum energy field. In examples, the modulation of the vacuum energy field is determined using an entropy trace analysis, coherence spectral signatures, symbolic propagation variance, or energy fluctuation profiles based on the scalar field.

The application of the modulation field outputs 414 energy and/or coherence metrics. The metrics define how the structured vacuum energy output has performed. In addition, the energy and/or coherence metrics can provide information on opportunities to improve performance. The vacuum modulation engine collects 416 real-time feedback, such as the energy and/or coherence metrics, in a feedback loop, and the vacuum modulation engine utilizes the performance to adjust the determination of the modulation field or the determination of future modulation fields.

In some examples, the vacuum modulation engine determines or measures modulation of the vacuum energy field after applying the modulation field to the vacuum energy field. For example, the vacuum modulation engine calculates the actual modulated vacuum energy and compares the modulated vacuum energy to an initial vacuum energy or to a predicted vacuum energy and determines the differences. In addition or alternatively, the vacuum modulation engine compares the modulated vacuum energy to a target vacuum energy. The vacuum modulation engine can make changes to the modulation field based on differences between the calculated values. For example, if a difference between any of the values is greater than or less than a threshold amount, the vacuum modulation engine adjusts the modulation field to reduce or increase the difference, respectively.

In an example, the vacuum modulation engine calculates a structured vacuum energy density of the structured vacuum energy output by multiplying a reduced Planck constant and a resonant frequency and dividing the product of the reduced Planck constant and the resonant frequency by a product of a speed of light to the third power and a square of 2π.

FIG. 5 is a multi-dimensional surface plot generated from an exponential modulation profile showing a modulation field, represented by the symbols “φs (x, y)”. The surface plot depicts structured vacuum energy density, denoted with the symbol “ρSVE”. The vertical axis represents the value of vacuum energy density, while the horizontal plane is defined by x and y coordinates. The surface plot was generated from an exponential modulation profile and demonstrates the influence of the modulation field (φs(x, y)) on the structured vacuum energy density (ρSVE). The surface of the plot illustrates a peak, or mound, with the highest density located at the center (x=0,y=0) and decreasing radially outwards. The shape of the surface plot is characteristic of an exponential modulation profile.

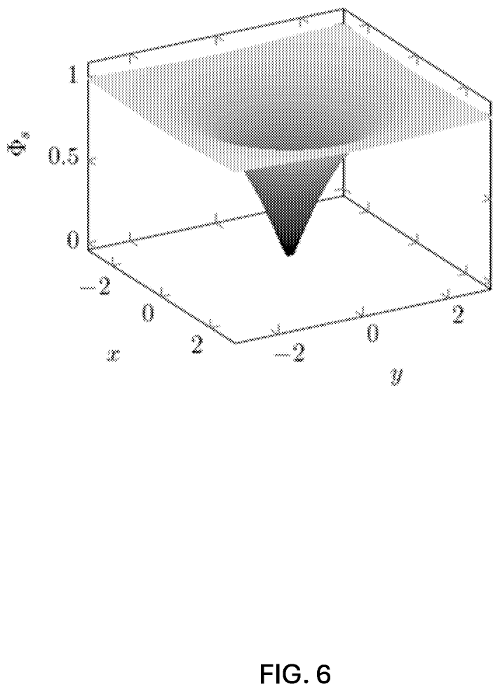

FIG. 6 is a multi-dimensional surface plot of a modulation field, represented by the symbols “φs(x, y)”. The surface plot illustrates a derived solution obtained from a Higgs-type potential. The plot shows the value of the modulation field (φs) on the vertical axis as a function of variables x and y on the horizontal plane. The surface plot visually represents a symbolic domain separation. For example, the surface plot demonstrates a radial kink structure representing symbolic domain separation and exhibiting topological field transitions. The radial kink structure is characterized by higher values of the modulation field (φs) in the peripheral regions and a distinct minimum or depression towards the center.

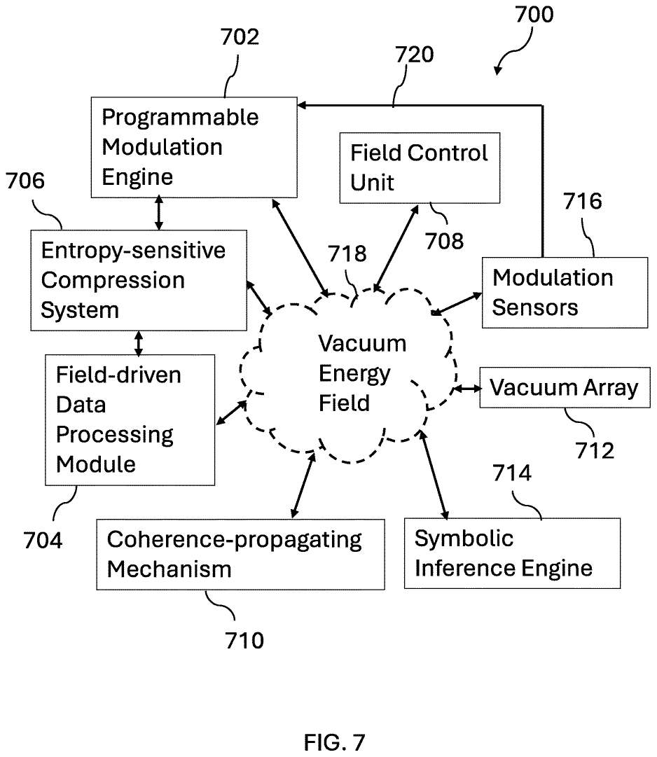

FIG. 7 is a box diagram of an example system 700 for manipulating structured vacuum energy interactions to process data. The system 700 includes hardware components such as programmable modulation engine(s) 702, field-driven data processing module(s) 704, entropy-sensitive compression system(s) 706, topology-adaptive field control unit(s) 708, coherence-propagating mechanism(s) 710, vacuum array(s) 712, symbolic inference engine(s) 714, and/or feedback-coupled modulation sensor(s) 716. In the example, the programmable modulation engines 702 are core units that are responsible for actively manipulating the properties of a vacuum energy field 718 within a defined spatial and temporal region. The programmable modulation engines 702 are configured to generate various types of field modulations, such as changes in vacuum energy density, fluctuations, or potentially even topological structures within the field. The programmable modulation engines 702 act as the actuators of the system 700. By precisely controlling parameters (e.g., frequency, amplitude, spatial distribution of applied energy or fields), the programmable modulation engines 702 induce the desired modulations in the vacuum energy field and facilitate a wide range of experiments, data encoding schemes, or even potential energy extraction protocols.

The field-driven data processing modules 704 directly utilize the modulated vacuum energy field as a medium for computation or information processing. Information is encoded in the specific states or patterns of the vacuum energy field modulations. The field-driven data processing modules 704 are designed to interact with and read out modulated states to perform logical operations or data transformations. The field-driven data processing modules 704 utilize the modulated vacuum energy fields and represent a paradigm shift in computation. Instead of relying on electronic or photonic signals, the field-driven data processing modules 704 leverage the inherent properties of the vacuum energy field 718 itself for processing.

The entropy-sensitive compression systems 706 are designed to analyze the information content or complexity (entropy) of the vacuum energy field modulations. Based on this analysis, the entropy-sensitive compression systems 706 dynamically adjust the parameters of the modulation engines 702 and/or the data processing modules 704 to achieve efficient encoding and transmission of information. The entropy-sensitive compression systems 706 efficiently compress and facilitate the processing of information in widespread practical applications by utilizing the high dimensionality and complexity of vacuum energy field states. For example, the entropy-sensitive compression systems 706 utilize compression algorithms specifically tailored to the unique characteristics of vacuum energy field data based on the modulation field and perform compression in real-time based on the calculated fields.

The topology-adaptive field control units 708 focus on the creation and manipulation of topological structures within the vacuum energy field 718. The topology-adaptive field control units 708 dynamically create, modify, and stabilize these non-trivial field configurations (e.g., analogous to solitons or instantons in field theories). Topological structures in energy fields are often associated with stability and unique properties. The ability to control and manipulate the topological structures provides new forms of information storage, robust computation, and/or improved energy transfer techniques.

The coherence-propagating vacuum arrays 712 are structured arrangements of components designed to enhance and direct the propagation of coherent excitations or modulations within the vacuum energy field over extended spatial or temporal scales. The coherence-propagating vacuum arrays 712 enable the reliable transmission of information encoded in vacuum energy field modulations or facilitate long-range interactions mediated by the vacuum.

The symbolic inference engines 714 are designed to perform high-level reasoning and deduction based on symbolic representations of the vacuum energy field states, modulations, and the outcomes of field-driven processes. The symbolic inference engines 714 operate on abstract symbols that represent complex energy field configurations or the results of computations performed within the vacuum. For example, the symbolic inference engines 714 provide automated discovery of new modulation protocols, error correction in vacuum-based computation, and/or high-level control of the topology-adaptive units based on the vacuum energy fields 718.

The feedback-coupled modulation sensors 716 are highly sensitive sensors designed to precisely measure the properties of the modulated vacuum energy field 718. The modulation sensors 716 are coupled to and send readings to the data processing modules 704 via a feedback loop 720. Readings from the feedback-coupled modulation sensor 716 are used to dynamically adjust the parameters of the data processing modules 704, creating a closed-loop control system for achieving and maintaining desired vacuum energy field states. This feedback loop facilitates precise manipulation and correction of any deviations from the intended modulations because the feedback loop provides accurate and real-time monitoring of the vacuum energy field. As a result, the feedback loop facilitates stability and control of the system in real-time.

The system 700 is an example application of modulation of vacuum energy fields. In further examples within the scope of the disclosure, the system 700 may include more, less, and/or different components. In addition, each of the components of the system 700 may be utilized individually, in different combinations, and/or incorporated into any of the described systems (e.g., systems 100, 700, and 1100).

FIG. 8 is a box diagram of an example symbolic inference engine 800. For example, the symbolic inference engine 800 is a core component of many Artificial Intelligence (AI) systems, such as those based on expert systems and knowledge-based systems. The symbolic inference engine 800 operates on symbolic representations of knowledge (e.g., rules, facts, logical expressions) to derive new conclusions or make decisions.

In the example, the symbolic inference engine 800 includes one or more knowledge databases 802, a working memory 804, an inference module 806, and a user interface 808. The symbolic inference engine 800 may be incorporated into one or more systems and the components of the symbolic inference engine 800 may be embodied on a single hardware system or distributed across hardware systems. For example, aspects of the knowledge database 802, the working memory 804, the inference module 806, and the user interface 808 may be stored on an onboard memory system and/or stored on a memory system accessed via a communication network (e.g., cloud storage). Further, the symbolic inference engine 800 may include other components such as a communication module to facilitate communication between components of the symbolic inference engine 800 and/or communication with external components.

The knowledge database 802 stores and organizes the knowledge that the symbolic inference engine 800 will use for reasoning. The knowledge database 802 encompasses a knowledge base and acts as a repository of domain-specific knowledge. The knowledge database 802 contains facts, rules, heuristics, and other information relevant to a problem domain. For example, the information in the knowledge database is represented in a symbolic form and includes facts such as simple assertions (e.g., “Socrates is a person”) and/or rules such as If-Then statements (e.g., “IF A AND B THEN C”). Also, the knowledge database 802 encompasses relationships, actions, and/or derivations between stored information. The knowledge database 802 also includes ontologies and/or taxonomies, which are structures that define concepts and their relationships (e.g., “A dog IS-A mammal”).

The inference module 806 applies logical rules and infers new facts or conclusions from information retrieved from the knowledge database 802 and/or the working memory 804. For example, the inference module 806 includes algorithms and procedures for manipulating the information in the knowledge database 802 and/or the working memory 804 to draw conclusions, solve problems, or make decisions. The inference module 806 implements specific reasoning strategies such as forward chaining, backward chaining, pattern matching, and resolution. Forward chaining is a data-driven reasoning strategy and starts with known facts and applies rules to derive new facts until a goal is reached or no more rules can be applied. An example of forward chaining is the statement: “If A is true and (If A then B) is a rule, then B is true.” Backward chaining is a goal-driven reasoning strategy and starts with a goal or hypothesis and works backward to find facts that support the hypothesis. An example of backward chaining is the statement: “To prove C, find a rule that concludes C, then try to prove the antecedents of that rule.” Pattern matching involves identifying patterns in data that correspond to rules or facts. Resolution is a general proof procedure used in logic such as automated theorem proofs.

The working memory 804 is a temporary storage area for facts, hypotheses, and intermediate conclusions that are being actively considered during an inference process. The working memory 804 is dynamic and changes as the system reasons. The working memory 804 holds the current state of the problem-solving process, including user inputs, inferred facts, sub-goals, and/or information retrieved from the knowledge database 802. The inference module 806 reads from and writes to the working memory 804.

The user interface 808 receives inputs from a user and/or outputs information from the inference module 806 to the user. For example, the user interface 808 may include a keyboard, a computer pointer device, a touch screen, a microphone, a camera, and/or any other suitable device that acts as a display device and/or an input device. The user interface 808 receives information such as initial facts, queries, and/or goals from the user. The user interface 808 outputs working feedback, conclusions, recommendations, and/or answers from the inference module 806 to the user. In some examples, the user interface 808 includes an explanation module that provides the chain of rules and facts that led to a particular conclusion (e.g., “I concluded X because of rule Y and fact Z”) to justify the reasoning of the inference module 806.

During operation, the symbolic inference engine 800 is configured to determine a coherence model using, for example, Equation (6). For example, the symbolic inference engine 800 receives inputs such as vacuum field information and/or information related to a coherence amplitude. The symbolic inference engine 800 reads or retrieves information from the knowledge database 802 and/or the working memory 804 to process the inputs. The retrieved information and the inputs are processed through the inference module 806, and the inference module 806 uses any of Equations (1)-(6) to calculate a coherence amplitude, a modulation field, structured vacuum energy, and/or other related measures. Based on the calculations, the symbolic inference engine 800 determines a coherence output. The symbolic inference engine 800 provides the coherence output via the user interface 808; the coherence output is used to change at least one operating parameter of a system including a vacuum field and, for example, reduce coherence loss.

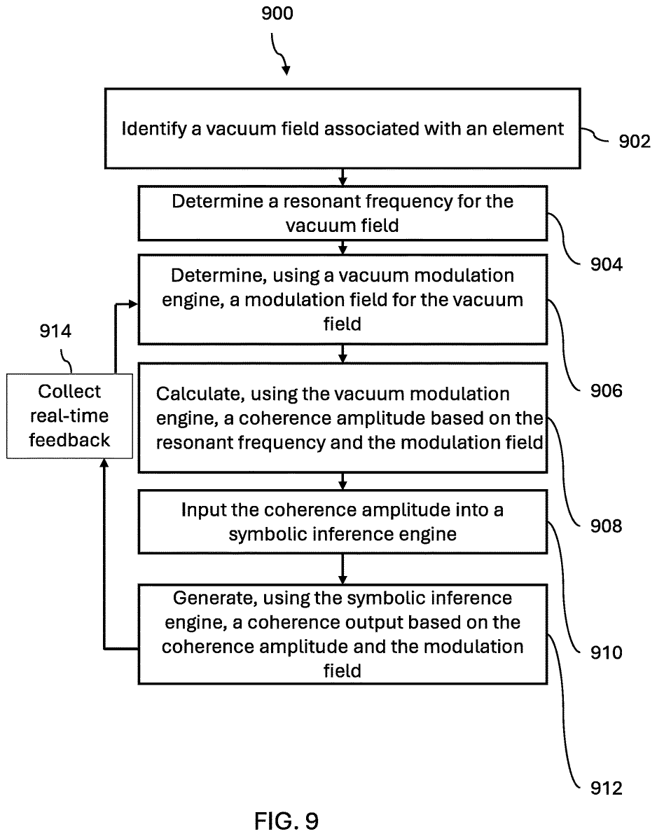

FIG. 9 is a flow diagram of an example method 900 for coherence modeling and manipulation based on vacuum energy fields. For example, a non-transitory computer-readable medium stores instructions that, when executed by a processor, cause the processor to perform the method 900.

Referring to FIGS. 1, 2, 8, and 9, in the method 900, a vacuum modulation engine (e.g., the modulation engine 104) identifies 902 a vacuum energy field (e.g., the vacuum energy field 124). For example, the vacuum energy field includes vacuum energy within a boundary.

The vacuum modulation engine determines 904 a resonant frequency for the vacuum energy field. For example, the vacuum modulation engine calculates the resonant frequency based on information about the element and/or a model of the element; the vacuum modulation engine receives the resonant frequency from an external input, and/or the vacuum modulation engine retrieves the resonant frequency from a database.

The vacuum modulation engine determines 906 a modulation field for the vacuum energy field. For example, the vacuum modulation engine uses any of equations (1)-(6) to calculate the modulation field; the vacuum modulation engine receives the modulation field from an external input, and/or the vacuum modulation engine retrieves the modulation field from a database. The modulation field and/or any other equation terms may be transformed using isomorphisms, domain substitutions (e.g., Fourier, Laplace), nonlinear embeddings, or variational encodings. In some examples, the modulation field may be selected from a group consisting of scalar, symbolic, tensorial, topological, or algorithmic fields.

Based on the resonant frequency and the modulation field, the vacuum modulation engine calculates 908 a coherence amplitude. For example, the vacuum modulation engine uses any of equations (1)-(6) to calculate the coherence amplitude. For example, the coherence amplitude is calculated according to equation (6) based on the resonant frequency and a selected modulation field. In some examples, the resonant frequency varies across a structured vacuum manifold or symbolic register.

The coherence amplitude is input 910 into at least one of a symbolic inference engine, a hybrid computing execution system, an entropy-encoded logic processor, a software development kit, a middleware platform, a cloud-executed runtime system, or a semiconductor-level coherence propagation unit. In the example, the coherence amplitude is input 910 into a symbolic inference engine (e.g., the symbolic inference engine 800), and the symbolic inference engine generates 912 a coherence output from the coherence amplitude and the modulation field. The coherence output may include a coherence profile and/or a coherence integration of substrate logic. The coherence output may outflow to software and/or hardware embodiments and/or be presented to a user and/or AI interface. In some examples, the system determines at least one of a symbolic coherence, an entropy regulation, or a logical propagation based on the modulation field.

The coherence output is structured to facilitate modulating the coherence and, thereby, reduce coherence loss. For example, an operating parameter of a system is adjusted based on the coherence output to reduce coherence loss. The operating parameter may relate to a modulation field applied to the system. For example, the modulation field is selected based on the modeled or calculated coherence to speed up or slow decay and/or increase or decrease oscillations, and thereby control the coherence amplitude. For example, a larger structured modulation field (φs) is selected to slow decay (i.e., generate a longer coherence time), while a smaller structured modulation field (φs) is selected to speed up decay.

In an example, the method 900 includes deterministically modulating, using a computational simulation platform, vacuum energy fields based on the coherence output to generate desired coherent amplitude states for symbolic or logical registers. In some examples, a modulation device (e.g., the modulation device 106) acts according to the vacuum modulation engine to apply topological modulation using the modulation field to reduce coherence loss.

In examples, the vacuum modulation engine collects 914 real-time feedback before, during, and/or after generation of the coherence output. For example, a monitoring and validation mechanism detects coherence integrity using entropy trace analysis, spectral signature profiling, symbolic propagation variance, or coherence envelope deviation. The real-time feedback facilitates precise tuning of the coherence output and instantaneous or preemptory corrections to the modulation field. The real-time feedback is collected 914 using sensors detecting operating parameters and/or based on results of computer modeling performed during operation of the system.

For example, the coherence output may include coherence metrics. The metrics define how the structured vacuum energy output has performed. In addition, the coherence output can provide information on opportunities to improve performance. The vacuum modulation engine collects 914 real-time feedback such as the energy and/or coherence metrics, in the feedback loop, and the vacuum modulation engine utilizes the performance to adjust the determination of the modulation field or the determination of future modulation fields.

In some examples, the method 900 includes governing coherence decay using the coherence output to provide half-life control.

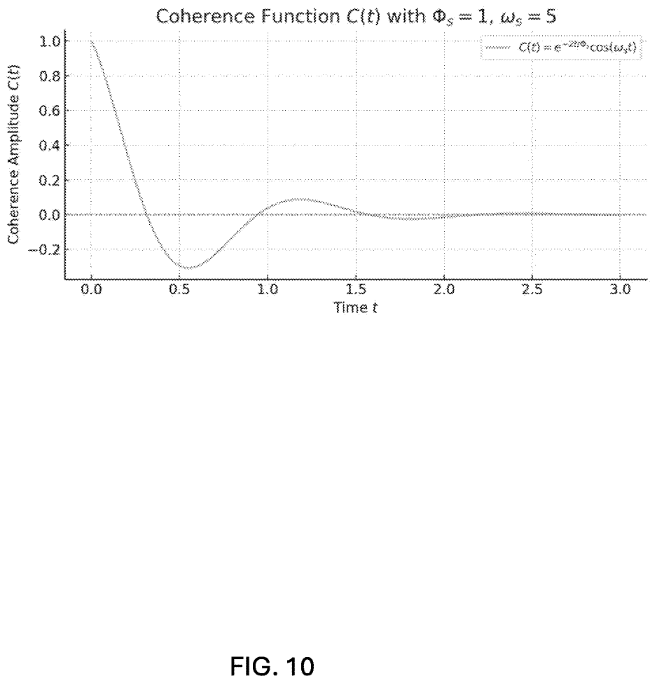

FIG. 10 is a diagram comparing coherence amplitude to time for a system employing vacuum field modulation. The diagram in FIG. 10 provides a time-domain visualization of coherence amplitude. Time (in seconds) is represented on the x-axis. The coherence amplitude is represented on the y-axis and is a function of time. The coherence amplitude is calculated according to Equation (6), for example. The coherence amplitude decreases and then approaches a 0 amplitude as time proceeds, representing an exponential decay envelope and phase-resolved oscillation governed by the resonant frequency (ωᵥ) and the structured modulation field (φs). The coherence amplitude is tuned by calculating and/or selecting a modulation field using any of the equations described herein. The modulation field is selected to, for example, reduce coherence loss.

Implementations of the described systems and methods include coherence-enhanced circuits, vacuum-synchronized logic clocks, entropy-governed state transition units, modulation-based AI controllers, field-tuned neural inference layers, classical/super computing hybrid buffers with phase retention, symbolic engines using coherence-guided inference, topologically encoded AI coherence clusters, adaptive hybrid logic systems, frequency-shifted coherence retention substrates, scalar-field synchronized entropy compression engines, enhanced computer hardware stacks applying tuned coherence logic for extended computing runtime, symbolic inference engines with coherence-retained decision pathways, entropy-aware AI that controls memory volatility via vacuum-encoded coherence, classical logic gates with structured coherence decay and symbolic field memory, cryptographic oscillators leveraging deterministic vacuum-driven coherence for key generation, middleware frameworks incorporating coherence-stable signal propagation across hybrid stacks, SDKs that inject coherence modulation as an optimization layer into user-defined logic, and/or coherence-aware chips integrating vacuum field modulation-synchronized memory and timing.

Also, the described systems and methods may be implemented in emergent and future architectures such as neuromorphic hardware, error correction codes with symbolic overlays, next-gen AI accelerators (e.g., brain-inspired co-processors, photonic AI chips), and/or mixed-domain cryptographic systems (e.g., PQC+noise-based modulation). For example, the described methods and systems are adaptable and provide effective coherence modulation for elements in any past, present, or future system.

Implementations of the described systems and methods improve hardware performance of a computing system. For example, the described engines provide faster execution, lower power usage, and more stability beyond what traditional control loops achieve for computer processing. In addition, the system improves execution efficiency, reduces thermal bottlenecks, and increases system resilience to load fluctuations. For example, the vacuum modulation engine overcomes stochastic constraints in vacuum modeling, eliminates entropic drift in symbolic/logical systems, enhances computational substrates with field-aware control, and enables cross-domain symbolic consistency. Moreover, the described systems and methods enhance information coherence in distributed systems.

The approach can be applied to different hardware forms such as general-purpose computer processing units (CPUs), application-specific integrated circuits (ASICs), field-programmable gate arrays (FPGAs), and/or superconducting logic circuits.

FIG. 11 is a partially schematic diagram of an example enhanced computing system, generally indicated at 1100. The enhanced computing system 1100 is configured, for example, to perform computing operations. The enhanced computing system 1100 includes processors 1101 and a basis-dependent coherence preservation engine 1106. Also, the enhanced computing system 1100 incorporates or is in communication with quantum processors 1102 that perform quantum operations. The basis-dependent coherence preservation engine 1106 operates the processors 1101 as described below to structure and preserve coherence and/or quantum characteristics when the quantum processors 1102 perform operations.

In addition, the enhanced computing system 1100 may include any other components that facilitate the enhanced computing system 1100 operating as described. For example, the enhanced computing system 1100 includes a cooling system 1108, a display device 1110, an input device 1112, structural supports 1114, and a memory 1116. For example, the input device 1112 may include a keyboard, a computer pointer device, a touch screen, a microphone, a camera, and/or any other suitable input device. In addition, the enhanced computing system 1100 includes at least one timer (not labeled in FIG. 1) that provides timing for execution and synchronization as described herein. The enhanced computing system 1100 may include more or less components in some examples. For example, the structural supports 1114 and/or the cooling system 1108 may be minimized, replaced, or omitted, because, in the example, the enhanced computing system 1100 provides improved performance without need for extensive and complex hardware that requires extensive support or cooling.

The memory 1116 may be any type of memory capable of use with the enhanced computing system 1100. For example, the memory 1116 may include a quantum memory and/or a binary memory. For example, the memory 1116 may comprise, but is not limited to, quantum memory (e.g., memory configured to store quantum information), volatile storage (e.g., random access memory), non-volatile storage (e.g., read-only memory), flash memory, or any combination of such memories. For example, the enhanced computing system 1100 may also include additional data storage media which may comprise devices (removable and/or non-removable) such as, for example, magnetic disks, optical disks, or tape. The memory 1116 may include an operating system and one or more program modules or components suitable for performing the various operations described above. The operating system may be suitable for controlling the operation of the enhanced computing system 1100. In some examples, a portion of the memory 1116 is stored on a database and accessed via a communication network (e.g., cloud storage).

As stated above, a number of program modules and data files may be stored in the memory 1116. While executing on the quantum processor 1102, the program modules may perform the various processes including, but not limited to, the aspects of the enhanced computing system 1100, as described herein. For example, aspects of the basis-dependent coherence preservation engine 1106 and/or the quantum operations are stored on the memory 1116 and accessed by the processors 1101 and/or the quantum processors 1102 when performing operations. The program modules may be incorporated into an operating system, application, middleware, and/or any other program module.

In the example, the enhanced computing system 1100 includes at least one of the processors 1101. For example, the processor 1101 may include one or more processing units, graphics units, communications units, system virtualization units and various application functionality all of which are integrated as a single integrated circuit or incorporated into multiple circuits.

In addition, in the example, the enhanced computing system 1100 includes a plurality of the quantum processors 1102 (e.g., a first quantum processor, a second quantum processor, a third quantum processor, etc.). For example, each quantum processor 1102 may include one or more processing units, graphics units, communications units, system virtualization units and various application functionality all of which are integrated as a single integrated circuit or incorporated into multiple circuits.

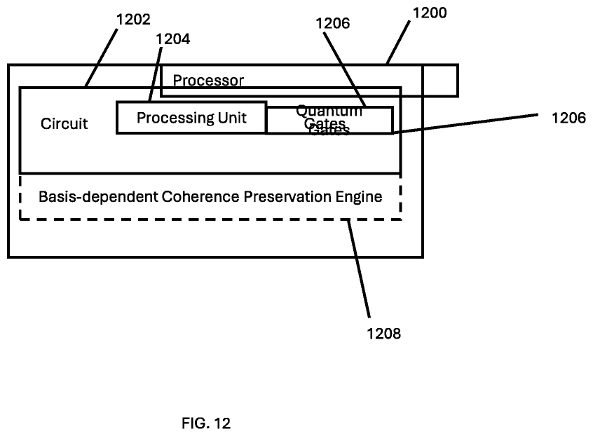

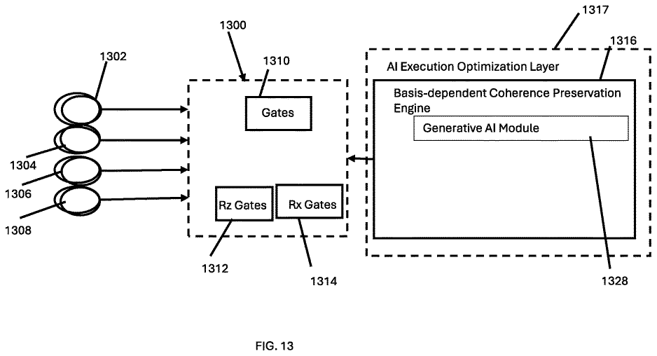

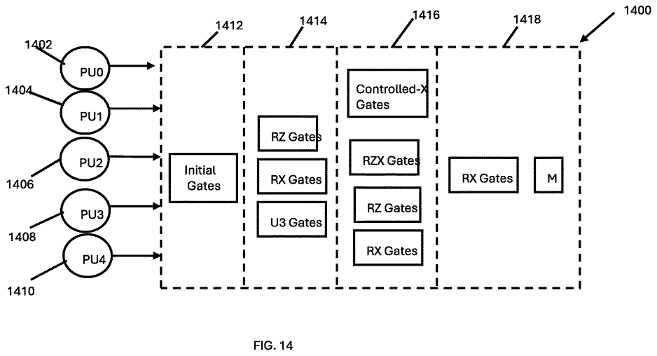

Also, in the example, each quantum processor 1102 includes at least one quantum circuit 1118 including discrete qubits 1120 connected to gates 1122. The qubits 1120 operate in a Z-axis, an X-axis, and a Y-axis to perform quantum operations. At least one of the qubits 1120 is characterized by anisotropic decoherence rates such that the dephasing rate in the Z-axis is greater than the dephasing rate in the X-axis or the Y-axis. An example quantum processor is illustrated in FIG. 12, and an example quantum circuit is illustrated in FIGS. 13 and 14. The gates 1122 may be any gates suitable for quantum operations. Examples of the gates 1122 include, without limitation, CNOT, Tofoli, ancillary, Pauli, and Hadamard gates.

The basis-dependent coherence preservation engine 1106 is programmed to measure a quantum state tomography of the qubit 1120 based in the Z-axis. For example, the quantum state tomographies are performed to measure off-diagonal elements of a density matrix in the Z-axis. The coherence value is suppressed in the quantum state tomography based in the Z-axis. The basis-dependent preservation engine 1106 determines gate operators to rotate the qubit in the X-axis and the Y-axis based on the quantum state tomography measured in the Z-axis and rotates the qubit 1120 in the X-axis and the Y-axis by applying the gate operators. For example, a Hadamard gate may be used to rotate the qubit 1120 on the X-axis and a combination of a S-dagger and Hadamard gate(s) may be used to rotate the qubit 1120 on the Y-axis. The operator(s) may be represented as unitary operators that change a measurement basis from a computation basis (e.g., the Z-axis) to an alternative Pauli basis (e.g., the X or Y-axis). In some examples, the basis-dependent coherence preservation engine 1106 is programmed to execute the quantum operation on the enhanced computing system 1100 with the qubit 1120 rotated according to the gate operators.

After rotation of the qubit 1120, the basis-dependent coherence preservation engine 1106 is programmed to measure a quantum state tomography of the qubit 1120 based in the X-axis and/or the Y-axis, and determine a coherence value of the qubit 1120 based on the quantum state tomography. In contrast to the quantum state tomograph in the Z-axis which displays suppressed coherence, the quantum state tomography of the qubit 1120 based in the X-axis and/or the Y-axis may be quantified as slow-decay meaning coherence is preserved for a longer period than in the Z-axis.

The coherence value may be determined using a basis-contrast witness that is a function of the total variation distance between the probability distributions in the Z-basis and at least one of the X-axis or Y-axis. In some examples, the coherence value is determined using an entropy-drop proxy, where the coherence is determined as a function of the Shannon entropy of the probability distributions in the X-axis or Y-axis relative to a maximum possible entropy.

In some examples, the basis-dependent coherence preservation engine 1106 utilizes a stored algorithm or equation to calculate a coherence value. In other examples, the coherence value is retrieved from a table or lookup based on information for the execution circuit. In further examples, the coherence value is provided to the basis-dependent coherence preservation engine 1106.

Equation (13) is used to calculate the basis relative coherence.

$${C}_{U} ( ρ ) = {\sum }_{i \neq j} \vert {( {UpU}^{†} )}_{ij} \vert \qquad Equation ( 13 )$$

based on the condition:

$$∃ U ∈ \{ I , {H}^{⊗ n} , {( {S}^{†} H )}^{⊗ n} \} s . t . {C}_{U} ( ρ ) ≫ {C}_{I} ( ρ )$$

where I is the identity operator, H represents a Hadamard gate, S^{†} is the Hermitian conjugate of a single-qubit S gate (or phase gate), n is an integer representing the composition of computational gates, and C_{I}(ρ) is a coherence measure of the state ρ in a computational basis of I, ρ∈ [symbol] ²^{ⁿ}^{×2}^{ⁿ} is a post circuit density matrix that represents the quantum state of the qubit, B={Z^{└n}} denotes a computational basis, U is a unitary operator that performs a change of basis (e.g., to another Pauli basis where U=H^{└n} for X, and U=S^{†} H^{⊗n} for Y), U^{†} is a Hermitian conjugate, i is a row index, and j is a column index.

A quantum state may be determined using a matrix in accordance with the following Equation (14).

$$ρ = \frac{1}{2} ( I + r * σ ) \qquad Equation ( 14 )$$

with Bloch vector represented by r=(rₓ, r_{y}, r_{z}) thus a general channel map is represented by r′=Tr+t
where T represents a real (e.g., 3×3) transfer matrix, t represents a translation vector that describes the effect of a general quantum channel, ρ represents a density matrix of a quantum state, I represents an identity operator, the Bloch vector represents a quantum state on a Bloch sphere, σ represents a vector of Pauli matrices, r′ represents a final Bloch vector after a quantum channel has acted on the state.

Example implementations of Equation (14) include a pure dephasing in Z basis, with a probability of p that is represented by

$${r}_{x}^{′} = ( 1 - 2 p ) {r}_{x} , {r}_{y}^{′} = ( 1 - 2 p ) {r}_{y} , {r}_{z}^{′} = {r}_{z} .$$

An amplitude damping, represented by γ, is shown by:

$${r}_{x}^{′} = \sqrt{1 - γ} {r}_{x} , {r}_{y}^{′} = \sqrt{1 - γ} {r}_{y} , {r}_{z}^{′} = ( 1 - γ ) {r}_{z} + γ .$$

For Equation (14), if λ_{x,y}>>λ_{z} is true then Z basis histograms appear decohered while X/Y basis retain visible structure. Accordingly, the basis-dependent coherence preservation engine 1106 transforms Z basis to X/Y basis to recover coherence that can be interpreted from the visible structure of the X/Y basis histograms but is suppressed in the Z basis.

In some examples, the quantum operation involves a plurality of the qubits 1120 operating in the Z-axis, the X-axis, and the Y-axis. Accordingly, the basis-dependent coherence preservation engine 1106 is configured to determine operating parameters for each of the qubits 1120.

In a two-qubit extension state, correlators are generated according to Equation (15):

$$ρ = \frac{1}{4} {\sum }_{α , β ∈ \{ I , X , Y , Z \}} {c}_{αβ} {σ}_{α} ⊗ {σ}_{β} \qquad Equation ( 15 )$$

For an n-Qubit state, the basis-dependent coherence preservation engine 1106 calculates transverse correlators using the following Equation (16).

$$ρ = \frac{1}{{2}^{n}} {\sum }_{P ∈ {P}_{n}} \hat{p} ( P ) P \qquad Equation ( 16 )$$

Equation (16) is further defined by Equation (17).

$$\hat{p} ( P ) = Tr ( pP ) \qquad Equation ( 17 )$$

Using Equations (15)-(17), X-based and Y-based correlators or coefficients are preserved and Z-based correlators or coefficients are suppressed. As a result, the basis-dependent coherence preservation engine 1106 facilitates extraction of coherence and previously obfuscated information that conventional systems disregarded as noise. For example, the basis-dependent coherence preservation engine 1106 recognizes and facilitates utilization of coherence in X-axis and Y-axis to gain additional information and usefulness of the qubit 1120 where information would otherwise be suppressed if the Z-axis basis was used.

The basis-dependent coherence preservation engine 1106 utilizes one or more witnesses to facilitate calculation of the coherence value and verify preservation of the coherence in the modified basis. For example, Equations (18)-(20) represent practical witness calculations.

Equation (18) provides a basis-contrast witness measure (W_{TVD}) for coherence.

$${W}_{TVD} = \frac{1}{2} ( TVD ( {P}_{Z} {P}_{X} ) + TVD ( {P}_{Z} {P}_{Y} ) , \qquad Equation ( 18 )$$

$$with TVD ( P , Q ) \frac{1}{2} \sum x \vert P ( x ) - Q ( x ) \vert$$

where the expression TVD(P,Q) represents the total variation distance between two probability distributions, P and Q. The probability distributions P and Q represent generic probability distributions of measurement outcomes. The variables P_{Z}, P_{X}, P_{Y} represent specific probability distributions from measurements in the Z, X, and Y bases.

Equation (19) provides an entropy-drop proxy measure for coherence.

$${C}_{b} = 1 - \frac{H ( {P}_{b} )}{log {2}^{n′}} with b ∈ \{ Z , X , Y \} \qquad Equation ( 19 )$$

where C_{b} represents the coherence measure in a specific basis b, H(P_{b}) represents the Shannon entropy of the probability distribution Pb in basis b, b∈{Z,X,Y} represents a variable indicating the measurement basis, which can be Z, X, or Y, and log 2ⁿ represents the maximum possible entropy for an n-qubit system.

Equation (20) provides a Pauli mass measure for coherence.

$${M}_{T} = {\sum }_{P ∈ {S}_{T}} \vert 〈 P 〉 \vert , {M}_{Z} = {\sum }_{P ∈ {S}_{Z}} \vert 〈 P 〉 \vert \qquad Equation ( 20 )$$

where M_{T} represents the transverse Pauli mass, which is the sum of the magnitudes of the expectation values for transverse (X/Y-heavy) Pauli operators, M_{Z} represents the Z-based Pauli mass, which is the sum of the magnitudes of the expectation values for Z-heavy Pauli operators, Σ_{P∈ST} represents a summation over all Pauli operators P in the set of transverse operators, S_{T}, Σ_{P∈SZ} represents a summation over all Pauli operators P in the set of Z-based operators, SZ, | [symbol] P [symbol] |, represents the magnitude of the expectation value of a Pauli operator P.

Equation (20) indicates that the transverse Pauli mass (MT) is significantly larger than the Z-based Pauli mass (MZ) for regimes expressing basis-dependent coherence suppression. The basis-dependent coherence preservation engine 1106 capitalizes on the difference in the distinct basis by transferring the basis to the basis more resistant to decay and, thereby, preserves coherence.

In some examples, the basis-dependent coherence preservation engine 1106 facilitates improved execution of quantum operations based on the preserved coherence. For example, the basis-dependent coherence preservation engine 1106 is programmed to analyze a quantum algorithm for execution on the enhanced computing system using the qubit, and identify portions of the execution of the quantum algorithm that are subject to Z-basis decoherence. Based on the identified portions of the execution of the quantum algorithm that are subject to Z-basis decoherence, the basis-dependent coherence preservation engine 1106 is programmed to perform transpilation of the quantum algorithm execution. The quantum algorithm is modified in the transpilation to replace a rotation about the Z-axis with rotation about the X-axis or the Y-axis for the identified portions of the execution. In some examples, the transpilation is performed using Pauli-frame updates and/or basis-routing. Additionally or alternatively, the basis-dependent coherence preservation engine 1106 performs echo scheduling during the execution of the quantum algorithm to stabilize coherence. For example, based on anisotropic eigenvalues (λₓ, λ_{y}, λ_{z}) the basis-dependent coherence preservation engine 1106 performs transpilation to route computation through slow-decay axes (e.g., X-axis, Y-axis) via, for example, Pauli-frame updates, basis-routing, and echo scheduling.

The basis-dependent coherence preservation engine 1106 is programmed to cause the quantum operation on the enhanced computing system in accordance with the quantum algorithm as modified in the transpilation.

The basis-dependent coherence preservation engine 1106 additionally or alternatively utilizes equations to characterize or verify system behavior according to basis-dependent coherence preservation. For example, Equation (21) is used to run tomography in Z, X, Y rotated bases.

$$\vert \overline{{{ρ}_{off}}^{( X , Y )}} \vert - \vert \overline{{{ρ}_{off}}^{( Z )}} \vert > 0 , with bootstrap CI excluding zero \qquad Equation ( 21 )$$

In a basis-dependent coherence domain, according to the tomography, the Z-basis (ρ^{(Z)} expresses diagonal-dominant results, while the X-basis (ρ^{(X)}) and the Y-basis (ρ^{(Y)}) express statistically significant off-diagonal results.

Equation (22) is used to determine anisotropic decoherence rates.

$${\dot{r}}_{x} = - {Γ}_{⊥} {r}_{x} ; {\dot{r}}_{z} = - {Γ}_{⊥} {r}_{z}^{*} ; {\dot{r}}_{y} = - {Γ}_{⊥} {r}_{y} \qquad Equation ( 22 )$$

According to Equation (22), if Γ_{∥}>>Γ_{⊥}, then coherence is suppressed in Z faster than in X/Y.

Equation (11) is used to provide masking witness derivation. For example, Equation (23) results for a single qubit where the Z-basis probability is represented by

$${p}_{Z} ( 0 , 1 ) = \frac{1 \pm {r}_{z}^{′}}{2} ,$$

### and the X-basis

$${p}_{x} ( \pm ) = \frac{1 \pm {r}_{x}^{′}}{2} .$$

$$TVD ( {P}_{Z} , {P}_{X} ) = \frac{1}{2} \vert {r}_{x}^{′} - {r}_{z}^{′} \vert \qquad Equation ( 23 )$$

The basis-dependent coherence preservation engine 1106 provides a software-defined quantum execution framework that dynamically optimizes quantum circuit execution by basis-dependent coherence preservation. In some examples, at least a portion of the basis-dependent coherence preservation engine 1106 is incorporated into middleware that facilitates communication between an operating system and an application (as shown in FIG. 5). For example, the middleware is implemented as a software exception layer that sits between a quantum application layer and a hardware layer. Suitably, the basis-dependent coherence preservation engine 1106 is not bound to physical quantum hardware but is compatible with different hardware to function as a transpilation, optimization, and/or execution enhancement middleware. In other examples, the basis-dependent coherence preservation engine 1106 is incorporated into a standalone application, an operating system, and/or any suitable platform. In some examples, operations of the basis-dependent coherence preservation engine 1106 are divided across middleware and execution level controls and/or are implemented in tightly integrated middleware and execution control packages. In further examples, the basis-dependent coherence preservation engine 1106 is not included in or does not interact with middleware.

Optionally, the enhanced computing system 1100 includes a qubit flux field stabilization engine 1104 including a software-defined flux energy execution modeling module that operates on the quantum processors 1102 and is configured to operate the quantum circuits 1118 to model a flux coherence field for each qubit 1120. For example, the qubit flux field stabilization engine 1104 models flux coherence fields associated with qubits 1120 in each quantum processor 1102 (e.g., a first flux coherence field for each first qubit in the first processor, a second flux coherence field for each second qubit, a third flux coherence field for each third qubit in the third quantum processor, etc.). The flux coherence field is a virtual field determined by the qubit flux field stabilization engine 1104. The flux coherence field for each qubit 1120 may be defined by a zone around the qubit 1120 bounded by one or more dimensions (e.g., a radius forming a sphere) that is determined based on characteristics of the qubit 1120. Interactions within the flux coherence fields of the qubits 1120 produce effects on the qubits 1120, which can change cohesion, quantum errors, and energy consumption. For example, the flux coherence field may comprise vacuum fluctuations that physically manifest themselves as a cloud of virtual photons (electron dressing) and move with a bare electron. Forces such as the vacuum fluctuations can interact with the environment and affect the qubit and can cause decoherence of the qubit.

Rather than relying on hardware modifications or other methods for static flux-bias calibration, the qubit flux field stabilization engine 1104 models the flux coherence fields and facilitates the system accounting for and making dynamic real-time adjustments based on the flux coherence fields and the interactions with the flux coherence fields. For example, the flux coherence fields are determined by Equation (24), where Φ_{eff}(t) represents the effective flux experienced by the qubit (incorporating both intrinsic bias and external stabilization), Φ₀ is the nominal qubit flux bias, and Σₙ Aₙe^{-t/T}^{ₙ} cos(ωₙt+θₙ) represent external noise sources weighted by AI-driven feedback.

$${Φ}_{eff} ( t ) = {Φ}_{0} + {\sum }_{n} {A}_{n} {e}^{- t / {T}_{n}} cos ( {ω}_{n} t + {θ}_{n} ) \qquad Equation ( 24 )$$

Based on the flux coherence fields, the qubit flux field stabilization engine 1104 identifies interactions among qubits 1120 and between the qubits 1120 and the environment around the qubits 1120. For example, quantum fluxes associated with the qubits 1120 exhibit resonant behaviors and, when interacting with matter or other fields (magnetic fields, vacuum, gravity, etc.), can generate structures within the flux coherence fields. The qubit flux field stabilization engine 1104 identifies, structures, and manipulates the flux coherence fields associated with the qubits 1120 and interactions with the flux coherence fields to improve performance of the enhanced computing system 1100. For example, the qubit flux field stabilization engine 1104 and the basis-dependent coherence preservation engine 1106 operate the quantum processors 1102 and optimize qubits through structured flux coherence field alignment, advanced error suppression, and multi-QPU synchronization to reduce interference among the flux coherence fields, reduce signal noise, and reduce power consumption of the quantum processors 1102.

The qubit flux field stabilization engine 1104 acts as a predictive coherence stabilization tool. Instead of just reacting to errors after the errors occur, the qubit flux field stabilization engine 1104 models fluctuations in coherence and proactively adjusts operations to prevent decoherence before the decoherence manifests. As a result, the system is able to restructure execution timing dynamically based on predicted coherence loss and minimize error propagation in real time. For example, a representative function for AI-modeled coherence stabilization is represented by Equation (25), where C₀ is the initial coherence, and Γ(t) is the AI-predicted decoherence function based on training with prior hardware fluctuations.

$$C ( t ) = {C}_{0} {e}^{- Γ ( t )} \qquad Equation ( 25 )$$

Using the predictive modeling, the qubit flux field stabilization engine 1104 facilitates execution timing and entanglement distribution remaining optimized across different quantum hardware platforms. Also, the qubit flux field stabilization engine 1104 implements information from the basis-dependent coherence preservation engine 1106 to further improve performance and preserve coherence. For example, basis-dependent coherence preservation anisotropy identified in the axes of the qubit 1120 corresponds to preferred vacuum-structured axes where flux (Φ₀) stabilizes coherence. The qubit flux field stabilization engine 1104 and the basis-dependent coherence preservation engine 1106 coordinate together to transpile and adjust parameters of the execution of the quantum operation to improve coherence. In some examples, the qubit flux field stabilization engine 1104 and the basis-dependent coherence preservation engine 1106 are incorporated together, included as stand-alone platforms, or partly included together. For example, in some examples, the basis-dependent coherence preservation engine 1106 provides parameters and information (e.g., the identified portions of the execution that exhibit basis-dependent coherence suppression) and the qubit flux field stabilization engine 1104 determines modifications for the execution and/or performs transpilation.

The qubit flux field stabilization engine 1104 provides a software-defined quantum execution framework that dynamically optimizes quantum circuit execution by leveraging structured flux energy modeling, flux stabilization, and qubit-induced coherence control. In some examples, at least a portion of the qubit flux field stabilization engine 1104 is incorporated into middleware that facilitates communication between an operating system and an application (as shown in FIG. 5). For example, the middleware is implemented as a software exception layer that sits between a quantum application layer and a hardware layer. Suitably, the qubit flux field stabilization engine 1104 is not bound to physical quantum hardware but is compatible with different hardware to function as a transpilation, optimization, and/or execution enhancement middleware. In other examples, the qubit flux field stabilization engine 1104 is incorporated into a standalone application, an operating system, and/or any suitable platform. In some examples, operations of the qubit flux field stabilization engine 1104 are divided across middleware and execution level controls and/or are implemented in tightly integrated middleware and execution control packages. In further examples, the qubit flux field stabilization engine 1104 is not included in or does not interact with middleware.

During operation, each qubit undergoes an adaptive stability process and flux energy principles are applied to prevent decoherence and entanglement loss. For example, the qubit flux field stabilization engine 1104 tracks and predicts interactions between the flux coherence fields of the qubits 1120 and the flux coherence fields of other qubits 1120, and/or between the flux coherence fields of the qubits 1120 and the environment to improve performance of the quantum processors 1102. Based on the recorded or predicted interactions, the qubit flux field stabilization engine 1104 adjusts operating parameters of the enhanced computing system 1100 in real time to manipulate (e.g., reduce, increase, or otherwise alter) the interactions between the flux coherence fields of the qubits 1120 and the flux coherence fields of other qubits 1120, and/or between the flux coherence fields of the qubits 1120 and the environment. The operating parameters are adjusted to align quantum execution with structured energy fluctuations for enhanced coherence, suppress quantum errors before execution errors propagate, and/or prevent decoherence of the qubits 1120. Examples of operating parameters that can be adjusted include, without limitation, coherence states, execution order, gate operations, and entanglement pathways. The adjusted operating parameters provide executions with optimized interactions that improve performance of the quantum processors 1102. During quantum operations, the qubit flux field stabilization engine 1104 provides at least two functions including 1) reducing drifting of the qubits 1120 due to quantum vacuum fluctuations, and 2) preventing distortion of the qubits 1120 due to noise.

For example, the qubit flux field stabilization engine 1104 dynamically adapts to quantum circuit execution by applying real-time flux corrections based on the quantum state evolution. The qubit flux field stabilization engine 1104 continuously monitors coherence fluctuations and adjusts the flux field using adaptive pulse shaping to counteract phase noise and energy decoherence. For example, during operation, the qubit flux field stabilization engine 1104 generates an instantaneous flux gradient at every time step. The instantaneous flux gradient may be calculated as a summation of the original or previous flux gradient added to a product of an adaptive energy gradient coefficient and fluctuations in the flux coherence fields (calculated or measured) minus a product of a correction factor for coherence loss and the rate of change of the fluctuation flux gradient.

In some examples, the qubit flux field stabilization engine 1104 measures surrounding field gradients before execution to establish a baseline field intensity matrix including representations of flux intensity at each qubit location. The qubit flux field stabilization engine 1104 detects phase distortions and/or flux field changes during execution and applies a corrective stabilization coefficient based on a dynamic compensation factor for the detected phase distortions. The corrective stabilization coefficient is multiplied by the sine of the product of the flux oscillation frequency and the time, and the resulting product is added to the baseline field intensity matrix. After execution, any residual decoherence is measured and the qubit flux field stabilization engine 1104 applies an adaptive backpropagation update for future executions. Accordingly, in some examples, the qubit flux field stabilization engine 1104 determines the baseline correction profile based at least partly on precomputed structured energy models and determines real-time flux measurements to provide dynamic corrections and respond instantly to the environmental noise in real-time.

The qubit flux field stabilization engine 1104 detects phase shifts in real-time and generates flux corrections within sub-microsecond latency. As a result, the qubit flux field stabilization engine 1104 prevents decoherence before the decoherence propagates and preserves quantum state fidelity without requiring additional logical qubits. In examples, the qubit flux field stabilization engine 1104 leverages a precomputed flux coherence field model for each qubit as a baseline and continuously refines predictions using real-time field measurements. In some such examples, the qubit flux field stabilization engine 1104 establishes an energy stabilization framework immediately prior to execution, and continuously refines flux values based on evolving coherence conditions to improve execution speed and accuracy.

The qubit flux field stabilization engine 1104 models quantum coherence fluctuations by analyzing interactions between qubits and their surrounding energy environment. For example, the qubit flux field stabilization engine 1104 and/or the basis-dependent coherence preservation engine 1106 utilizes a three-layer predictive framework that integrates fluctuations, quantum state evolution, and adaptive learning mechanisms. In layer one, the qubit flux field stabilization engine 1104 models the effect of energy fluctuations on qubit phase stability. For example, the qubit flux field stabilization engine 1104 and/or the basis-dependent coherence preservation engine 1106 determines coherence decay patterns based on gate sequences. The qubit flux field stabilization engine 1104 and/or the basis-dependent coherence preservation engine 1106 adjusts or updates, in real-time, the Hamiltonian equation for the quantum operation to account for transient energy shifts. The adjustments may be inferred for each qubit individually or for one or more groups of the qubits. The time-dependent coherence losses for each qubit are multiplied by the number of qubits and then summed to obtain a total coherence loss. Then a model of the structured field adjustments is summed to obtain the total field adjustments. The base circuit Hamiltonian is adjusted by the total field adjustments and the total coherence loss to obtain an adaptive Hamiltonian, which is used in further quantum operations.

Layer two involves a quantum state evolution prediction. The qubit flux field stabilization engine 1104 and/or the basis-dependent coherence preservation engine 1106 includes an artificial intelligence that trains on historical coherence loss data and uses the historical coherence loss data to predict upcoming phase shifts. Also, the qubit flux field stabilization engine 1104 and/or the basis-dependent coherence preservation engine 1106 uses a modeling technique such as a stochastic Schrödinger equation solver to estimate coherence drift probability based on coherence decay rate and predicted drift onset time.

In layer three, the qubit flux field stabilization engine 1104 and/or the basis-dependent coherence preservation engine 1106 dynamically adjusts qubit rotation angles before execution to mitigate coherence loss. For example, the qubit rotation angles are adjusted based on the coherence values determined by the basis-dependent coherence preservation engine 1106. The qubits 1120 are rotated using operators (e.g., Hadamard gates or Pauli gates) to change the basis from the Z-axis for portions of the execution that have been identified as displaying potential for suppression in coherence. The qubits 1120 are switched to the X-axis and Y-axis basis where coherence is identified as having a slower decay. In addition, the qubit flux field stabilization engine 1104 makes any other adjustments that may provide improved performance based on determinations of the qubit flux field stabilization engine 1104 and/or the basis-dependent coherence preservation engine 1106.

In addition, the qubit flux field stabilization engine 1104 and/or the basis-dependent coherence preservation engine 1106 applies filtering, such as Kalman filtering, to refine error suppression over multiple executions. For example, the qubit flux field stabilization engine 1104 and/or the basis-dependent coherence preservation engine 1106 adjusts rotation gates by a counter rotation angle to accommodate a predicted phase drift. As a result, the qubit flux field stabilization engine 1104 and the basis-dependent coherence preservation engine 1106 prevent decoherence before the decoherence accumulates in multi-qubit interactions.

In some examples, the qubit flux field stabilization engine 1104 and the basis-dependent coherence preservation engine 1106 are generally hardware-agnostic and are compatible with a broad range of computing architectures, including superconducting qubit platforms, quantum processing units, and hybrid quantum-classical computing infrastructure. For example, the qubit flux field stabilization engine 1104 applies software-driven resonance tuning, among other features, and, in some examples, adjusts dynamically based on hardware-specific error profiles. For example, the qubit flux field stabilization engine 1104 identifies the hardware platform for the quantum operation and determines an error profile that is appropriate for the identified hardware. For superconducting qubit platforms, the qubit flux field stabilization engine 1104 may use flux compensation to correct microwave-driven phase shifts. For trapped ion qubits, the qubit flux field stabilization engine 1104 adapts to ion heating effects by adjusting laser pulse stability. For photonic qubits, the qubit flux field stabilization engine 1104 applies polarization noise filtering to reduce photon loss errors. As such, the qubit flux field stabilization engine 1104 is simple and cost-effective to incorporate into or add to existing quantum computing infrastructures.

In examples, at least a portion of the qubit flux field stabilization engine 1104 and/or the basis-dependent coherence preservation engine 1106 is implemented in different layers and/or components of the enhanced computing system 1100 or auxiliary systems. For example, the qubit flux field stabilization engine 1104 and/or the basis-dependent coherence preservation engine 1106 may be implemented in an execution layer that interacts directly with qubits. In one example, the qubit flux field stabilization engine 1104 and/or the basis-dependent coherence preservation engine 1106 utilizes hardware-embedded execution logic (e.g., field programmable gate arrays, application-specific integrated circuits, etc.) to process quantum instructions. In another example, the qubit flux field stabilization engine 1104 and/or the basis-dependent coherence preservation engine 1106 is included on a self-contained quantum control unit that pre-processes and optimizes execution without interfacing with external middleware. In some examples, aspects of the qubit flux field stabilization engine 1104 and/or the basis-dependent coherence preservation engine 1106 are incorporated into an on-chip quantum control system that executes, optimizes, and stabilizes quantum circuits. Such embodiments may operate without interfacing with middleware or requiring input from external sources.

Alternatively, at least some aspects of the qubit flux field stabilization engine 1104 and/or the basis-dependent coherence preservation engine 1106 are incorporated into offboard sources (e.g., cloud-based systems). For example, aspects of the qubit flux field stabilization engine 1104 and/or the basis-dependent coherence preservation engine 1106 may utilize cloud-based execution services that process and optimize quantum tasks externally before sending instructions to hardware.

Also, the qubit flux field stabilization engine 1104 and/or the basis-dependent coherence preservation engine 1106 may rely on networked quantum execution systems in which distributed quantum nodes collaborate in execution without needing middleware coordination. In addition, a protocol for the qubit flux field stabilization engine 1104 and/or the basis-dependent coherence preservation engine 1106 may optimize and schedule jobs before they reach the quantum processors 1102.

In some examples, computer processors utilizing binary bits are configured to implement aspects of the qubit flux field stabilization engine 1104 and/or the basis-dependent coherence preservation engine 1106 to determine quantum executions before the instructions are sent to the quantum processors 1102. In some examples, the computations on the computer processors are enhanced on quantum processors, such as using quantum-enhanced classical scheduling to handle gate execution dynamically.

In examples, aspects of the qubit flux field stabilization engine 1104 and/or the basis-dependent coherence preservation engine 1106 are implemented in various stages of processing and pre-processing qubit operations. For example, the qubit flux field stabilization engine 1104 may introduce an error mitigation protocol at the execution level that dynamically corrects noise without needing middleware intervention. Also, the qubit flux field stabilization engine 1104 and/or the basis-dependent coherence preservation engine 1106 may use real-time coherence tracking built into the execution layer. Further, the qubit flux field stabilization engine 1104 may implement flux stabilization techniques controlled directly by the execution layer. In addition or alternatively, the basis-dependent coherence preservation engine 1106 may implement coherence preservation techniques controlled directly by the execution layer.

Execution of the enhanced computing system 1100 may be decentralized across multiple systems. For example, a blockchain-based execution layer may optimize and validate quantum computations in a distributed network. Also, the enhanced computing system 1100 may utilize peer-to-peer quantum job execution and leverage execution-level consensus mechanisms. In other examples, the enhanced computing system 1100 creates a tokenized execution framework that assigns quantum tasks dynamically without a centralized system.

The enhanced computing system may have a quantum networking stack where execution synchronization occurs in any layer. In other examples, the enhanced computing system may have a network or device-based execution system.

The enhanced computing system 1100 may include one or more communication systems that enable communication by and between components of the enhanced computing system 1100 and/or facilitate or otherwise enable the enhanced computing system 1100 to communicate with remote computing devices. Examples of suitable communication connections include, but are not limited to, radio frequency (RF) transmitter, receiver, and/or transceiver circuitry, and/or universal serial bus (USB), parallel, and/or serial ports. Communication systems may also comprise physical ports (i.e., Ethernet or fiber optic) or wireless antenna and supporting hardware, which enable the enhanced computing system 1100 to send or receive data over an internet connection. The communication systems may include a network that is wired and/or wireless and utilizes any suitable communication protocols, including, but not limited to, internet, cellular, Wi-Fi, Bluetooth, near-field communication, or other wireless (or wired) communication protocols.

FIG. 12 is a block diagram of an example quantum processor 1200 for use with the enhanced computing system 1100. The quantum processor 1200 includes a quantum circuit 1202, including qubits 1204 and gates 1206, and a basis-dependent coherence preservation engine 1208. In further examples, the quantum processor 1200 includes or is connected to other modules, such as the qubit flux field stabilization engine 1104 shown and described in relation to FIG. 11. However, the qubit flux field stabilization engine 1104 may not be required for some examples of the quantum processor 1200.

Each qubit 1204 represents a unit of information for the quantum processor 1200. In examples, qubits are electrons, holes, ions, photons, atoms, molecules, artificial atoms, and/or any other atomic or subatomic particle suitable for use in achieving a quantum effect. For example and without limitation, each qubit 1204 in the quantum processor 1200 is represented by a trapped ion. Each qubit 1204 has at least two states. For example and without limitation, the operating status of each qubit 1204 can be characterized by directions of electron spin or polarization orientations of a photon. The operating status of the qubits 1204 represents computing information and enables the qubits 1204 to be used to perform quantum operations. In addition, the qubits 1204 each are capable of superposition. Superposition occurs when the qubit 1204 has an equal possibility of two or more states. Superposition allows the quantum processor 1200 to explore the consequences of both states of the qubit 1204 simultaneously and facilitates complex quantum calculations.

Although this disclosure refers to qubits in the examples, a quantum processor could utilize qubits, qutrits, qudits, and/or any units of quantum information. Accordingly, references to qubits in the disclosure and the claims should be considered to cover any units of quantum information, unless stated otherwise.

The quantum processor 1200 processes information and performs quantum operations by manipulating the operating status of the qubits. For example, the gates 1206 or other components of the quantum processor 1200 operate on sets of the qubits 1204 to define execution pathways for the qubits 1204. The gates 1206 provide reversible logic transformations that act on the qubits 1204. The gates 1206 each can act on one, two, or more of the qubits 1204. For example and without limitation, the gates 1206 may include microwave systems that emit pulses of microwave radiation. The state of the qubit 1204 acted on by one of the gates 1206 will switch if the frequency of the microwave matches the resonant frequency of the qubit 1204, and/or based on pulse duration or other characteristics of the microwave radiation. In further examples, the gates 1206 include lasers, magnetic fields, microwaves, and/or any qubit transformation devices.

The basis-dependent coherence preservation engine 1208 models coherence for the qubits during execution and facilitates preserving coherence that is lost in other systems. For example, the basis-dependent coherence preservation engine 1208 identifies portions of the execution where the coherence is lost in a first basis and transforms the execution such that the coherence is preserved in a second different basis. For example, the basis-dependent coherence preservation engine 1208 determines operators that cause the qubits 1204 related to the identified portions of the execution to rotate or switch from the first basis to the second basis. In an example, the qubits 1204 are rotated from a Z-axis basis to an X-axis or Y-axis basis. In some examples, the basis-dependent coherence preservation engine 1208 is configured to selectively control the gates 1206 based on determined or modeled coherence values to preserve coherence.

In some examples, the basis-dependent coherence preservation engine 1208 includes a generative artificial intelligence (AI) that is configured to determine operating parameters of the quantum processor in real-time to facilitate preservation of coherence and/or further improve performance of the quantum processor 1200. The generative artificial intelligence actively modifies execution pathways in real-time. For example, the basis-dependent coherence preservation engine 1208 is configured to identify potential bases for coherence loss and adjust at least one operating parameter of the quantum processor 1200 to reduce the opportunity for the coherence loss to occur. For example, the AI may cause dynamic changes in the axis basis of the qubits 1204 in real time to switch the qubits 1204 to a basis with a decreased rate of coherence loss. The generative artificial intelligence may run simulations to predict the coherence and determine the best way to reduce the loss based on the current and potential axes basis of the qubits 1204.

The generative artificial intelligence of the basis-dependent coherence preservation engine 1208 facilitates the basis-dependent coherence preservation engine 1208 dynamically adjusting the quantum processor 1200 in real time to improve performance. For example, the generative artificial intelligence provides optimized quantum circuit execution by guiding the restructuring of the gates 1206 and/or the qubits 1204. The generative artificial intelligence determines AI-driven execution logic via modeled flux coherence fields to dynamically improve performance. In addition, the basis-dependent coherence preservation engine 1208 provides an AI-powered self-calibrating quantum execution system that continuously refines quantum circuit parameters based on real-time execution feedback to improve overall stability. As a result, the basis-dependent coherence preservation engine 1208 enables circuits 1202 to execute faster while maintaining increased accuracy. In addition, in some examples, the basis-dependent coherence preservation engine 1208 selects gates that maintain structured entanglement during operation and, thereby, increase coherence time.

Also, in examples, the basis-dependent coherence preservation engine 1208 minimizes decoherence effects caused by state collapse during final readout operations. For example, the generative artificial intelligence models the measurement process and determines how measurements will affect the state stability of the qubits. The generative artificial intelligence predicts or records measurement-induced state stability issues and determines executions during measurement and readout that correct or prevent the stability issues in real-time based on the models. As a result, the basis-dependent coherence preservation engine 1208 facilitates measurement-induced stability of the qubits.

In addition, the basis-dependent coherence preservation engine 1208 provides state evolution mapping in which the compiler determines and controls state transitions of the qubits 1204 using software-based modeling instead of letting the quantum states evolve randomly under noise. As a result, the basis-dependent coherence preservation engine 1208 prevents quantum information from “leaking” due to vacuum instability.

In some examples, the basis-dependent coherence preservation engine 1208 includes a compiler that analyzes the circuits 1202 to implement aspects of the basis-dependent coherence preservation engine 1208. For example, the compiler identifies opportunities to cancel out rotations or to commute the gates 1206 in a way that clusters idle periods for the qubits 1204. By clustering idle times, the basis-dependent coherence preservation engine 1208 can schedule protective measures (e.g., dynamic decoupling or bias adjustments) during the intervals to reduce errors and/or stabilize the qubits 1204. In addition, the compiler maps the qubits 1204 to physical locations based on noise or flux parameters at the physical location. For example, on a superconducting processor, qubits 1204 at the edges of a chip may experience less interference from cross-talk, and the qubits 1204 located near a cavity in the chip may be protected from interference. The compiler uses calibration data and determines noise spectra of each physical qubit location. The compiler maps logical qubits 1204 with heavy workloads to the locations of the qubits 1204 that fit best based on the noise profile at the physical locations. The compiler may work across a single processor, or across multiple processors in a multi-QPU system. In the multi-QPU system, the compiler maps the qubits 1204 to locations in the logic based on considerations such as entanglement cost between modules, local gate fidelity, and/or the noise profiles at physical locations on different processors.

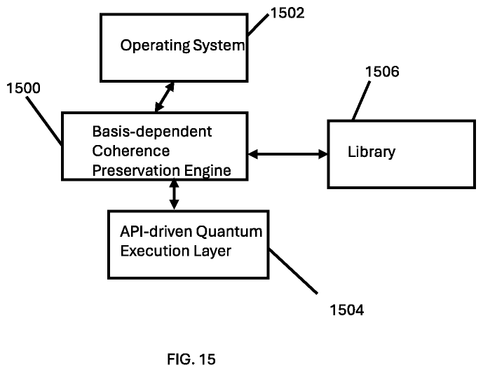

The compiler outputs a circuit such as the circuit shown in FIG. 13 or FIG. 15. In some examples, the compiler outputs annotations or directives that are interpreted by other layers of the basis-dependent coherence preservation engine 1208 and implemented during operation of the quantum computer.

In examples, the compiler is at least partly within the execution layer, within middleware layers, and/or is within any operating layer. For example, the compiler may be an execution-level compiler that pre-processes quantum circuits before running them on hardware and uses a real-time circuit adaptation engine that translates high-level quantum programs directly into hardware-native instructions.

FIG. 13 is a partially schematic diagram of a portion of an example quantum processor including a quantum circuit 1300. The quantum circuit 1300 includes qubits 1302, 1304, 1306, and 1308 arranged along the circuit 1300. In the example, the quantum circuit 1300 includes four qubits 1302, 1304, 1306, and 1308. In other examples, the quantum circuit 1300 can include more or less than four of the qubits 1302, 1304, 1306, and 1308.

The qubits 1302, 1304, 1306, and 1308 are acted on by gates such as Hadamard gates 1310. The Hadamard gates 1310 facilitate state changes of the qubits 1302, 1304, 1306, and 1308 and cause the qubits 1302, 1304, 1306, and 1308 to switch to superposition.

In addition, the quantum circuit 1300 includes positional gates 1312, 1314. The positional gates include a rotation operator gate 1312 (e.g., a CNOT gate) to control rotation of the qubits 1302, 1304, 1306, and 1308, and diagonal and rotation operator gates 1314 (e.g., controlled-Z gates) that control rotation and/or linear movement of the qubits 1302, 1304, 1306, and 1308. In other examples, the quantum circuit 1300 may include other gates without departing from some aspects of the disclosure. In some examples, the gates 1310, the gates 1312, and/or the gates 1314 may be omitted. In another example, the circuit 1300 includes universal single-qubit rotation gates or any other suitable gates.

While not necessarily shown in FIG. 13, the quantum circuit 1300 may also include resistors, capacitors, and/or any other circuit components.

A basis-dependent coherence preservation engine 1316 is configured to interact with the quantum circuit 1300. The basis-dependent coherence preservation engine 1316 is configured to operate the quantum circuit 1300 and facilitate quantum operations. The basis-dependent coherence preservation engine 1316 includes a generative artificial intelligence (AI) module 1328.

In the example, an AI execution optimization layer 1317 encompasses the basis-dependent coherence preservation engine 1316. The AI execution optimization layer 1317 actively modifies execution pathways in real-time based on modeling generated by generative artificial intelligence. In some examples, the AI execution optimization layer 1317 includes a feedback loop to provide continual or incremental quantum coherence adjustments.

The basis-dependent coherence preservation engine 1316 determines coherence values as described herein and operates the quantum circuit 1300 to preserve coherence values. For example, the basis-dependent coherence preservation engine 1316 utilizes generative artificial intelligence 1328 that facilitates the basis-dependent coherence preservation engine 1316 determining and adjusting parameters of the quantum circuit 1300 in real-time based on the coherence values. For example, the generative artificial intelligence 1328 runs simulations based on the qubit basis and the possible operations of the quantum circuit to predict bases that are subject to decoherence. The basis-dependent coherence preservation engine 1316 determines operating parameters that alter the timing and operation of the gates 1310, 1312, 1314 to rotate the qubits to a basis that preserves coherence.

During operation, the quantum circuit 1300 receives a command for a quantum computational operation. The computational operation includes a series of gate operations and timing that define execution pathways for the qubits for performing the quantum computational operation. The basis-dependent coherence preservation engine 1316 determines coherence values for each qubit based on their current axis basis and evaluates predicted loss or changes of coherence values based on projected execution pathways and adjusts the execution pathways to preserve coherence.

The basis-dependent coherence preservation engine 1316 projects execution pathways for the qubits 1302, 1304, 1306, and 1308. The execution pathways include operations of the Hadamard gates 1310, the gates 1312, and/or the gates 1314 and cause the decay of coherence of at least some of the qubits 1302, 1304, 1306, and 1308. The basis-dependent coherence preservation engine 1316 recognizes the identified coherence loss and determines if the coherence loss occurs in a different axis basis. For example, the basis-dependent coherence preservation engine 1316 may identify that coherence is suppressed for at least one of the qubits 1302, 1304, 1306, 1308 in the Z-axis basis while the coherence is preserved in the X-axis basis and/or the Y-axis basis. The basis-dependent coherence preservation engine 1316 transforms the information from the Z-axis basis to the X-axis basis and/or the Y-axis basis to preserve the coherence.

If the basis-dependent coherence preservation engine 1316 determines that the execution can be improved by modifying the axes-basis of the execution, the basis-dependent coherence preservation engine 1316 adjusts the operation of the Hadamard gates 1310, the gates 1312, and/or the gates 1314 to rotate the qubits 1302, 1304, 1306, and 1308 to another axes-basis. In some examples, the basis-dependent coherence preservation engine 1316 provides modified execution pathways based on the adjustments to the operation of the Hadamard gates 1310, the gates 1312, and/or the gates 1314. The quantum circuit 1300 performs the quantum operations using the modified execution pathways. As a result, the quantum circuit 1300 improves the performance of the quantum circuit 1300.

The quantum circuit 1300 generates a final measurement and readout optimization when the quantum computations are complete. The qubits 1302, 1304, 1306, and 1308 are measured for data extraction. In some examples, the basis-dependent coherence preservation engine 1316 optimizes the measurement process to prevent collapse of the quantum states, prevent errors due to collapse of the quantum states, and generate an accurate translation of quantum results into a readable data format. For example, before measurement, the basis-dependent coherence preservation engine 1316 transforms any axes basis (e.g., Z-axis) in which the coherence was suppressed into a different axis basis (e.g., X-axis or Y-axis) in which coherence is preserved. Accordingly, the basis-dependent coherence preservation engine 1316 facilitates extraction of information from the quantum circuit 1300 output even if the readout initially is obfuscated by the coherence loss in the first basis. In some examples, the basis-dependent coherence preservation engine 1316 applies final coherence corrections to reduce measurement noise, and a quantum error suppression module adjusts phase misalignments before quantum collapse occurs. As a result, readout data from the qubits 1302, 1304, 1306, and 1308 is extracted with minimal loss or state distortion. In some examples, the basis-dependent coherence preservation engine 1316 does not necessarily make dynamic changes to the execution of the quantum circuit 1300 and transforms execution output from the quantum circuit 1300 that would otherwise be seen as noisy due to coherence loss.

FIG. 14 is a schematic diagram of a portion of an example quantum circuit 1400. The circuit 1400 includes a first qubit 1402, a second qubit 1404, a third qubit 1406, a fourth qubit 1408, and a fifth qubit 1410. The qubits 1402, 1404, 1406, 1408, 1410 are acted upon by gates on execution pathways. Example gates include RZ(θ) gates, RX(θ) gates, U3(θ, φ, λ) gates, Hadamard (H) gates, controlled-X gates, and RZX(θ) gates.

The RZ(θ) gate rotates a qubit around the Z-axis of the Bloch sphere by an angle θ. When executed, the RZ(θ) gate leaves the X and Y coordinates unchanged. In addition, the RZ(θ) gate changes phase information without affecting measurement probabilities in the computational basis.

The RX(θ) gate rotates a qubit around the X-axis of the Bloch sphere by an angle θ. The RX(θ) gate can move a qubit between the poles of the Bloch sphere. The RX(θ) gate affects probability amplitudes in addition to phase. The RX(θ) gate is used in qubit flipping operations because the RX(θ) gate can map a first state (e.g., state |0 [symbol] ) to a superposition or to a second state (e.g., state |1 [symbol] ). The RX(θ) gate provides for single-qubit state preparation.

The U3(θ, φ, λ) gate is a single-qubit rotation that allows rotation around all three Bloch sphere axes (X, Y, Z). The U3 gate can express any single-qubit unitary transformation and is a generalized form of RX, RY, and RZ gates. For example, the U3 gate is used when fine-tuned qubit state preparation is needed.

The Hadamard (H) gate creates equal superposition by rotating qubits 45° about the X+Z axis. The H gate transforms computational basis states.

The CNOT (e.g., controlled-X/XOR Gates) is a two-qubit gate where one qubit (control) determines the flipping of another qubit (target). A CNOT gate is used for quantum entanglement and error correction. If the control qubit is in a second state (e.g., state |1 [symbol] ), the target qubit flips between the first state (e.g., state |0 [symbol] ) and the second state (e.g., state |1 [symbol] ).

The RZX(θ) gate is a two-qubit controlled rotation gate. The RZX(θ) gate applies an RX(θ) rotation on the target qubit controlled by the state of the first qubit. The RZX(θ) gate is used to optimize quantum state synchronization and coherence adjustments.

Measurement and final readout are provided by a measurement operator represented by (M) in the quantum circuit 1400. The measurement operator collapses quantum states into classical bits (e.g., “0”s and “1”s), and ensures the final computational result is extracted after all optimizations.

During operation of the quantum circuit 1400, a first layer 1412 includes quantum state initialization. In the first layer 1412, Hadamard gates (H) are applied to the qubits 1402, 1404, 1406, 1408, 1410 to place the qubits 1402, 1404, 1406, 1408, 1410 in superposition for parallel execution.

A second layer 1414 applies phase and coherence optimizations. For example, RZ(θ), RX(θ), and U3 gates apply dynamic phase and coherence adjustments. The operations stabilize quantum entanglement before entangling operations.

A third layer 1416 includes entanglement and execution pathway optimizations. In the third layer 1416, the controlled-X (CNOT) and RZX(θ) gates generate multi-qubit correlations. Also, dynamic RX and RZ adjustments refine the execution pathway.

A fourth layer 1418 includes readout and phase correction. In the fourth layer 1418, the RX gates are used to provide rotations and adjust the qubits 1402, 1404, 1406, 1408, 1410 before measurement. The qubits 1402, 1404, 1406, 1408, 1410 are measured (M) to extract final results.

While the illustrated example shows gates in specific layers, this is for illustrative purposes and does not limit the arrangement of the gates. In some examples, the gates may be included in different layers or arranged in any manner. For example, the gates may be rearranged dynamically to improve performance of the circuit 1400 based on feedback during operation of the circuit 1400.

The circuit 1400 uses AI-driven operation of the H, R, RZ (e), RX (e), U3, CNOT, and/or RZX(θ), for example, to adjust the basis of the qubits 1402, 1404, 1406, 1408, 1410 and preserve coherence as described herein. The circuit 1400 is compatible with multi-QPU execution due to software-controlled RZX entanglement structure. Also, no additional qubits are required because the circuit 1400 utilizes software-defined execution to stabilize coherence. The final measurements are outputted and verified to ensure that the optimizations improve computational accuracy.

FIG. 15 is a block diagram of an example integration of a basis-dependent coherence preservation engine 1500. The basis-dependent coherence preservation engine 1500 is incorporated into middleware that facilitates communication between an operating system 1502 and an application 1504. For example, the application 1504 is an API-driven quantum execution layer.

The basis-dependent coherence preservation engine 1500 interacts with a quantum library 1506 to provide quantum state control. The quantum library may be any standard commercial libraries and/or custom libraries. The quantum library can include machine instructions such as, for example and without limitation, calibration procedures, hardware tests, quantum algorithms, quantum gates, etc. For example, the basis-dependent coherence preservation engine 1500 reads or extracts commands, quantum executions, and/or quantum information from the quantum library 1506.

During operation, the basis-dependent coherence preservation engine 1500 acts as an interface between the operating system 1502 and the application 1504. For example, the basis-dependent coherence preservation engine 1500 communicates with the application 1504 using directives or abstractions to simplify the processing of the application 1504 and translates the directives into commands and data that enable the operating system to implement the directives. The basis-dependent coherence preservation engine 1500 communicates with the quantum library 1506 to provide information or retrieve quantum executions. In addition, the basis-dependent coherence preservation engine 1500 may provide authentication and other functions. The basis-dependent coherence preservation engine 1500 facilitates scalability of the system because the basis-dependent coherence preservation engine 1500 is able to interact with any platform.

In the example, while interacting with the operating system 1502 and the application 1504, the basis-dependent coherence preservation engine 1500 determines and/or rearranges quantum execution operations to reduce errors, enhance entanglement, and stabilize coherence of the qubits. For example, the basis-dependent coherence preservation engine 1500 receives directives from the application relating to a quantum operation to be performed and/or an initial quantum execution. The basis-dependent coherence preservation engine 1500 performs AI error detection to correct quantum execution, adjusts coherence stabilization dynamically based on modeled qubit flux fields, and provides circuit-level optimization without modifying physical qubits. The basis-dependent coherence preservation engine 1500 provides a final quantum execution to the operating system 1502 for operation and receives continuous feedback during operation to monitor and dynamically adapt the real-time operation.

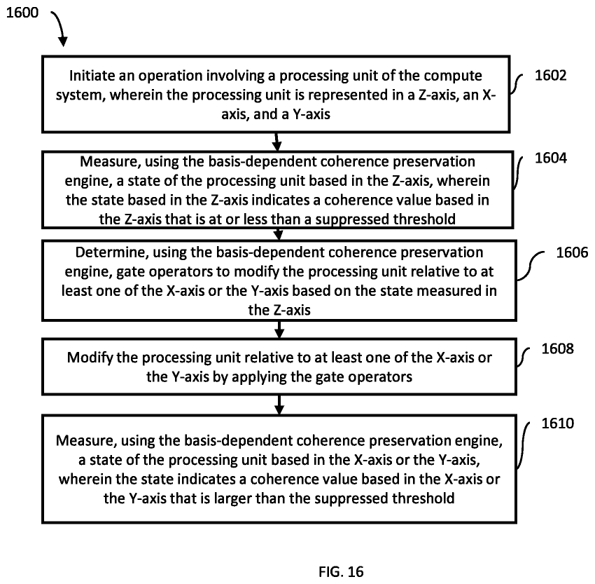

FIG. 16 is a flow diagram of an example method 1600 of operating an enhanced computing system (e.g., the enhanced computing system 1100 shown in FIG. 11). The method 1600 starts when a user initiates 1602 a quantum operation involving a qubit of the enhanced computing system. The qubit operates in a Z-axis, an X-axis, and a Y-axis. For example, the qubit may be characterized by anisotropic decoherence rates such that the dephasing rate in the Z-axis is greater than the dephasing rate in the X-axis or Y-axis. In some examples, the quantum operation involves a plurality of qubits and the steps of the method 1600 are performed for multiple qubits together and/or for individual qubits.

A basis-dependent coherence preservation engine (e.g., the basis-dependent coherence preservation engine 1106 shown in FIG. 11) measures 1604 a quantum state of the qubit based in the Z-axis. For example, a quantum state tomography in the Z-axis is performed to measure off-diagonal elements of a density matrix. The quantum state indicates a coherence value of the qubit in the Z-axis that is at or less than a suppressed threshold. The suppressed threshold is a preselected value that indicates the coherence is suppressed and/or at risk of being suppressed. The suppressed threshold may be selected based on the specific parameters of the system or may be a generic number that is used for any system. For example, the suppressed threshold may be zero or close to zero (e.g., to indicate the qubit has lost coherence).

The basis-dependent coherence preservation engine determines 1606 gate operators to rotate the qubit in the X-axis and the Y-axis based on the quantum state measured in the Z-axis. In some examples, the basis-dependent coherence preservation engine dynamically determines in real-time the optimum gates to perform the rotation. In further examples, the basis-dependent coherence preservation engine retrieves and/or selects the gates from a set of gates {e.g., I,H⊗n, (S†H)⊗n gates} provided for a system that exhibits basis-dependent coherence suppression.

The qubit rotates 1608 relative to at least one of the X-axis or the Y-axis by applying the gate operators. In some examples, the qubit is rotated before the quantum operation and the quantum operation is executed on the enhanced computing system with the qubit in the rotated position.

The basis-dependent coherence preservation engine measures 1610 a quantum state of the qubit based in the X-axis or the Y-axis. The quantum state indicates a coherence value of the qubit based in the X-axis or the Y-axis that is larger than the suppressed threshold. For example, the coherence value is suppressed in the quantum state based in the Z-axis but preserved in the Y-axis and/or the X-axis. Accordingly, the coherence value is not suppressed in the X-axis and/or the Y-axis and the basis-dependent coherence preservation engine has provided improved coherence values.

In some examples, the basis-dependent coherence preservation engine determines a coherence value of the qubit based on the quantum state based in the X-axis or the Y-axis. The basis-dependent coherence preservation engine utilizes any of the described equations to calculate the coherence value. For example, the basis-dependent coherence preservation engine measures off-diagonal elements of a density matrix in the X-axis or the Y-axis to perform a quantum state tomography. The basis-dependent coherence preservation engine is able to determine the coherence value using the Y-axis and/or the X-axis to preserve the information that would otherwise be suppressed. The coherence value is a quantifiable measure of the coherence for the qubit relative to a basis and facilitates extracting useful information that would otherwise be suppressed. Accordingly, the basis-dependent coherence preservation engine provides information from qubits in which coherence was suppressed in one or more bases.

In some examples, the coherence value is determined using a basis-contrast witness. The basis-contrast witness is a function of the total variation distance between the probability distributions in the Z-basis and at least one of the X-axis or Y-axis. In further examples, the coherence value is determined using an entropy-drop proxy, and coherence is determined as a function of the Shannon entropy of the probability distributions in the X-axis or Y-axis relative to a maximum possible entropy. In some examples, the coherence value is determined using a witness based on a Pauli mass.

In some examples, the basis-dependent coherence preservation engine provides adjustments pre-execution of the quantum operation to shift the basis of some qubits and preserve coherence. For example, the basis-dependent coherence preservation engine analyzes a quantum algorithm for execution on the enhanced computing system using the qubit, and identifies portions of the execution of the quantum algorithm that are subject to Z-basis decoherence. The basis-dependent coherence preservation engine performs transpilation of the quantum algorithm execution based on the identified portions of the execution of the quantum algorithm that are subject to Z-basis decoherence. For example, the quantum algorithm is modified in the transpilation to replace a rotation about the Z-axis with a rotation about the X-axis or the Y-axis for the identified portions of the execution. In some examples, the transpilation is performed using Pauli-frame updates and/or basis routing.

The quantum operation is executed on the enhanced computing system in accordance with the quantum algorithm as modified in the transpilation. Some examples involve performing echo scheduling during the execution of the quantum algorithm to stabilize coherence.

The described systems and methods provide technical advantages and improve the technology of systems. For example, systems and methods are described that improve the performance of computing systems using structured vacuum energy fields. For example, the described systems and methods include a basis-dependent coherence preservation engine that facilitates preserving coherence by shifting the basis to a basis having reduced coherence or signal decay. The described systems and methods are compatible with a broad range of computing architectures, including superconducting bit platforms, processing units, and other computing platforms. For example, the described systems and methods increase the capacity of computing systems by providing more efficient operation and enhanced capabilities of the processors. The described systems and methods have advantages for platforms beyond just the scope of computing systems and can be implemented in any suitable environment, including elements with vacuum energy fields.

The described systems and methods provide technical advantages and improve the technology of systems. For example, systems and methods are described that improve the performance of computing systems using structured vacuum energy fields. For example, the described systems and methods include a vacuum modulation engine that delivers modulation fields to vacuum energy fields and generates structures within the vacuum energy fields. The described systems and methods are compatible with a broad range of computing architectures, including superconducting bit platforms, processing units, and other computing platforms. For example, the described systems and methods increase the capacity of computing systems by providing more efficient operation and enhanced capabilities of the processors. The described systems and methods have advantages for platforms beyond just the scope of computing systems and can be implemented in any suitable environment, including elements with vacuum energy fields.

In addition, the described systems and methods provide modeling and tuning of coherence using structured vacuum energy fields. The systems and methods replace unpredictable decoherence with deterministic modulation, facilitate programmable control over logical state stability, enable symbolic coherence in AI and inference systems, reduce entropy drift in both symbolic and physical systems, provide a platform for coherent state preservation across hybrid stacks, facilitate scalable deployment in software development kits (SDKs), application programming interfaces (APIs), embedded logic, and hardware, and facilitate runtime detection of coherence fidelity for secure and stable execution.

As will be appreciated based on the foregoing specification, the above-described embodiments of the disclosure may be implemented using computer programming or engineering techniques including computer software, firmware, hardware or any combination or subset thereof, wherein the technical effect is to provide enhanced computing. Any such resulting program, having computer-readable code means, may be embodied or provided within one or more computer-readable media, thereby making a computer program product, (i.e., an article of manufacture), according to the discussed embodiments of the disclosure. As used herein, the terms “computer-readable media” or “non-transitory computer-readable media” are intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the terms “computer-readable media” or “non-transitory computer-readable media” include all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

Any past, current, or future computing technology implementing deterministic coherence modulation via structured vacuum or logical field interaction, regardless of platform, is within the scope of this disclosure.

When introducing elements of the present disclosure, the articles “a”, “an”, “the” are intended to mean that there are one or more of the elements. The terms “comprising”, “including” and “having” are intended to be inclusive and mean that there may be additional elements other than the listed elements. Moreover, the use of “top”, “bottom”, “above”, “below” and variations of these terms is made for convenience, and does not require any particular orientation of the components.

As various changes could be made in the above without departing from the scope of the disclosure, it is intended that all matter contained in the above description and shown in the accompanying drawings shall be interpreted as illustrative and not in a limiting sense.

What is claimed:

1. A system for tuning coherence of a computing system, said system comprising:
a modulation engine including at least one processor and a memory including computer-executable instructions that cause the at least one processor to:
identify an energy field;
determine a resonant frequency for the energy field;
determine a modulation field for the energy field;
calculate a coherence amplitude based on the resonant frequency and the modulation field; and
determine a coherence output based on the coherence amplitude; and
a modulation device connected to the modulation engine and incorporated into the computing system, wherein the modulation device is configured to adjust an operating parameter of the computing system based on the coherence output to reduce coherence loss of the computing system.

2. A system in accordance with claim 1, wherein the modulation engine is configured to calculate the coherence amplitude using a time-dependent function.

3. A system in accordance with claim 2, wherein the modulation engine is configured to calculate an exponential decay term by dividing time by the modulation field.

4. A system in accordance with claim 3, wherein the modulation engine is configured to calculate an oscillatory term that is a cosine function of the resonant frequency multiplied by time.

5. A system in accordance with claim 4, wherein the modulation engine is configured to calculate the coherence amplitude by multiplying the exponential decay term by the oscillatory term.

6. A method for tuning coherence in a system involving energy fields, said method comprising:
identifying an energy field associated with an element of the system;
determining, using a modulation engine, a resonant frequency for the energy field;
determining, using the modulation engine, a modulation field for the energy field;
calculating, using the modulation engine, a coherence amplitude based on the resonant frequency and the modulation field;
determining a coherence output based on the coherence amplitude; and
adjusting, based on the coherence output, an operating parameter of the system to reduce coherence loss.

7. A method in accordance with claim 6, wherein the coherence amplitude is calculated using a time-dependent function.

8. A method in accordance with claim 7, further comprising calculating an exponential decay term by dividing time by the modulation field.

9. A method in accordance with claim 8, further comprising calculating an oscillatory term that is a cosine function of the resonant frequency multiplied by time.

10. A method in accordance with claim 9, wherein the coherence amplitude is calculated by multiplying the exponential decay term by the oscillatory term.

11. A method in accordance with claim 6, further comprising:
inputting the coherence amplitude into a symbolic inference engine; and
generating, using the symbolic inference engine, the coherence output based on the energy field and the modulation field.

12. A method in accordance with claim 6, further comprising calculating the modulation field, where the modulation field satisfies at least one of the following equations:
□φs+V′(φs)=0 and/or ∂μ(f(φs)∂μφs)=ρs.

13. A method in accordance with claim 6, wherein the modulation field is selected from a group consisting of scalar, symbolic, tensorial, topological, or algorithmic fields.

14. A method in accordance with claim 6, further comprising governing coherence decay using the coherence output to provide half-life control.

15. A method in accordance with claim 6, wherein ωs varies across a structured manifold or symbolic register.

16. A method in accordance with claim 6, further comprising determining at least one of a symbolic coherence, an entropy regulation, or a logical propagation based on the modulation field.

17. A method in accordance with claim 6, further comprising inputting the coherence amplitude into at least one of a symbolic inference engine, a hybrid computing execution system, an entropy-encoded logic processor, a software development kit, a middleware platform, a cloud-executed runtime system, or a semiconductor-level coherence propagation unit.

18. A method in accordance with claim 6, further comprising detecting, using a monitoring and validation mechanism, coherence integrity using entropy trace analysis, spectral signature profiling, symbolic propagation variance, or coherence envelope deviation.

19. A method in accordance with claim 6, wherein the modulation field is transformed using isomorphisms, domain substitutions (e.g., Fourier, Laplace), nonlinear embeddings, or variational encodings.

20. A method of operating an enhanced computing system, the method comprising:
initiating a quantum operation involving a qubit of the enhanced computing system, wherein the qubit operates in a Z-axis, an X-axis, and a Y-axis;
measuring, using a basis-dependent coherence preservation engine, a quantum state of the qubit based in the Z-axis;
identifying a Z-basis decoherence if the quantum state based in the Z-axis indicates a coherence value of the qubit based in the Z-axis that is at or less than a suppressed threshold;
determining, using the basis-dependent coherence preservation engine, gate operators to rotate the qubit relative to at least one of the X-axis or the Y-axis based on the quantum state measured in the Z-axis;
rotating the qubit relative to at least one of the X-axis or the Y-axis by applying the gate operators;
measuring, using the basis-dependent coherence preservation engine, a quantum state of the qubit based in the X-axis or the Y-axis;
determining if the quantum state of the qubit based in the X-axis or the Y-axis indicates a coherence value of the qubit based in the X-axis or the Y-axis that is larger than the suppressed threshold;
analyzing, using the basis-dependent coherence preservation engine, a quantum algorithm for execution on the enhanced computing system using the qubit;
identifying, using the basis-dependent coherence preservation engine, portions of the execution of the quantum algorithm that are subject to the Z-basis decoherence;
performing transpilation of the quantum algorithm execution based on the identified portions of the execution of the quantum algorithm that are subject to Z-basis decoherence to replace a rotation about the Z-axis with a rotation about the X-axis or the Y-axis for the identified portions of the execution; and
executing the quantum operation on the enhanced computing system in accordance with the quantum algorithm as modified in the transpilation.
